(19) United States
(12) Patent Application Publication
(10) Pub. No.: US 2007/0118844 A1
(43) Pub. Date: May 24, 2007

(54) Designer and player for web services applications

(76) Inventors: Jin Huang, Mountain House, CA (US); Pawan Nachnani, Newark, CA (US); Sampath Thasampalayam, Fremont, CA (US); Lawrence Lindsey, Livermore, CA (US); Paul M. Tabet, Danville, CA (US)

Correspondence Address: MORRISON & FOERSTER LLP, 755 PAGE MILL RD, PALO ALTO, CA, 94304-1018, US

(21) Appl. No.: 11/286,267

(22) Filed: Nov. 23, 2005

(51) Int. Cl. G06F 9/46; G06F 9/44

(52) U.S. Cl. 719/330; 719/316

(57) ABSTRACT

In the computer field, method and apparatus for supporting web services so as to allow use of web services across organizations and allow use of the web services as a data source for a software application. This allows access to the database of another organization via web services with access via a web browser. One may access a field of data, a group of fields of data or a table of data or other types of software objects including logic. The present system maps or binds software object to software object between the accessing system and the accessed system. The web service access may be supported in a hosted manner by a server maintained by yet a third organization.

The specification includes Appendixes A, B, C, and D, which form part of the disclosure. Appendix A includes a schema describing the structure of an XML data mapping. Appendix B includes a format for XML-based invocations, and Appendix C contains an example invocation XML document. Appendix D contains an example XML description of attribute bindings, column bindings, and filters.

### FIELD OF THE INVENTION

This invention relates to computers and the Internet, and more specifically to web services.

### BACKGROUND

Web services are well known in the computer software field. Generally a web service is a computer application (software) component accessible over open protocols. Web services are intended for purposes of interoperability, for instance for enterprise application integration and business-to-business integration. This addresses the problem that enterprises (i.e., organizations) face in integrating their various software applications with one and other. Typically, even inside one organization there may be several computer systems even using different operating systems. These need to communicate and exchange information to serve the needs of the organization. This is exacerbated with cross-enterprise collaboration. Hence the need for interoperability. Web applications are also well known and are a type of distributed application built around web browsers. They typically use a computer language such as XML.

More precisely a web service is an application component that communicates via open protocols, processes XML messages, describes the messages using XML schema, and provides an endpoint description using WSDL. WSDL is the Web Service Description Language. WSDL makes it possible to describe an endpoint for a message and its behavior. WSDL layers additional information over the XML schema definitions that describe actual messages. Hence WSDL provides meta-information about, for instance, a computer file to be accessed.

Web services are web-based enterprise applications that use open XML standards and transport protocols to exchange data with calling clients (programs). The calling client may be at the same organization or at a different organization. Organization here does not necessarily refer to a particular business or legal entity, but instead any organization that maintains a networked computer system.

### SUMMARY

In accordance with this disclosure there is provided a web services framework to support existing and future web service requirements. In one example the web services here are used with software objects such as software applications (i.e., programs) which carry out a business process. See commonly owned Patent Application entitled “Browser Based Designer and Player,” filed Sep. 30, 2005, inventors Pawan Nachnani et al., Ser. No. 11/241,073, incorporated herein by reference in its entirety, which describes a method of building software applications. The sort of software applications disclosed in that Patent Application may also be used in the system of the present disclosure. The present inventors have determined that it would be useful to support web services in software applications, and other software objects, and executing same. Hence the present method and apparatus are directed to use of web services to make the web service a data source for a software application, and in one aspect to such use of web services in software applications built using the methods described in the “Browser Based Designer and Player” patent application referenced above. This use of web services may be in addition to sourcing data from a database supported by the same organization as the software application in question.

A goal is to access databases and/or business logic of other organizations via web services. Typically the web service is used to access objects, which may include data and operations (logic), in another organization's computer system. What is accessed is generally referred to herein as a software object. A software object includes data and/or operations from the other organization's computer system. The access is typically over the Internet but not so limited. The data source accessed may be a single field of data, a group of fields of data, or a table of data. Moreover there are provided adapters which allow access to web services supported by each of a number of different organizations each having a different type of computer system and/or database. In one embodiment the present system is hosted by yet a third organization which maintains a host server which includes a routing engine, a multi-tenant database and a process control module for web services.

By defining bindings between software objects such as application user interface components to other software objects such as web services or attributes of web services, one can build composite software applications which draw objects from several different organizations. These bindings can be represented as, for example, data in an Extensible Markup Language (XML) based format. Thus one software application can have objects drawn from a number of enterprises. In addition to the hosted server there is a player module which operates at runtime to run the application and a designer module which is the builder of the application. The adapters are provided for each accessed organization's objects because of differences in the objects and associated data. Typically there is at least one adapter for each web service vendor. Examples of web service vendors include Siebel® and Salesforce.com®. The present method accesses a WSDL (Web Service Definition Language) description for each vendor, this description being a standard metadata type well known in the field for describing web service interfaces. Typically there is one such WSDL description for each object or entity (enterprise or organization). Also included is a wizard which is part of the web services designer which creates the binding or mapping of meta-information to generate composite or other software applications. Typically the present system is coded in Java™, but is not so limited and is intended to be used via standard web browsers such as Microsoft Internet Explorer, again not so limited.

### BRIEF DESCRIPTION OF THE DRAWINGS

FIG. 1A is an illustrative drawing of a system for developing and executing browser-based applications.

FIG. 1B is an illustrative drawing of a binding between an application component and a web service.

FIGS. 1C and 1D are illustrative drawings of an example binding between an application component and a web service.

FIG. 1E is an illustrative drawing of a flowchart of a process for defining a binding between an application and a web service.

FIG. 1F is an illustrative drawing of a flowchart of a process for defining a web service lookup in an application player.

FIG. 2A is an illustrative drawing of defining an application text input component in an Application Designer.

FIG. 2B is an illustrative drawing of defining an application button component in an Application Designer.

FIG. 3 is an illustrative drawing of defining a web service connection in a web services Designer.

FIGS. 4A-4D are illustrative drawings of binding an application component in a web services Designer.

FIGS. 5A-5B are illustrative drawings of adding filters in a web services Designer.

FIGS. 6A-6B are illustrative drawings of adding columns in a web services Designer.

FIG. 7 is an illustrative drawing of defining a table area in an Application Designer.

FIG. 8 is an illustrative drawing of binding application table columns in a web services Designer.

FIG. 9 is an illustrative drawing of adding filters in a web services Designer.

FIG. 10 is an illustrative drawing of adding columns in a web services Designer.

FIG. 11 is an illustrative drawing of an application in an Application Player.

FIGS. 12A-12C are illustrative drawings of a selection lookup table in a web services Player.

FIG. 13 is an illustrative drawing of an application in an Application Player with data retrieved from a web service.

FIGS. 14A-14C are illustrative drawings of a selection lookup table in a web services Player.

FIG. 15 is an illustrative drawing of an application in an Application Player with data retrieved from a web service.

FIG. 16 is an illustrative drawing of implementation interfaces and objects.

FIG. 17 is an illustrative drawing of a process for authenticating a user.

FIG. 18 is an illustrative drawing of a process for invoking a lookup.

FIG. 19 is an illustrative drawing of a process for processing multiple pages of results.

FIG. 20 is a flowchart of an exemplary portion of a method to be executed by a Designer or a Player for looking up web service objects.

FIG. 21 is a flowchart of an exemplary portion of a method to be executed by a server for looking up web service objects.

FIG. 22 is a flowchart of an exemplary portion of a method to be executed by a Designer or a Player for inserting, updating, or deleting web service objects.

FIG. 23 is a flowchart of an exemplary portion of a method to be executed by a server for inserting, updating, or deleting web service objects.

FIG. 24 is an illustrative drawing of a Designer user interface.

FIG. 25 is an illustrative drawing of a user-defined script in an action builder.

### DETAILED DESCRIPTION

The following description is presented to enable one skilled in the art to make and use the present invention, and is provided in the context of particular uses and their requirements. Various modifications to preferred embodiments will be readily apparent to those skilled in the art, and the generic principles defined herein and may be applied to other embodiments and applications without departing from the spirit and scope of the invention. Moreover, in the following description, numerous details are set forth for the purpose of explanation. However, one of ordinary skill in the art will realize that the invention, might be practiced without the use of these specific details. In other instances, structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

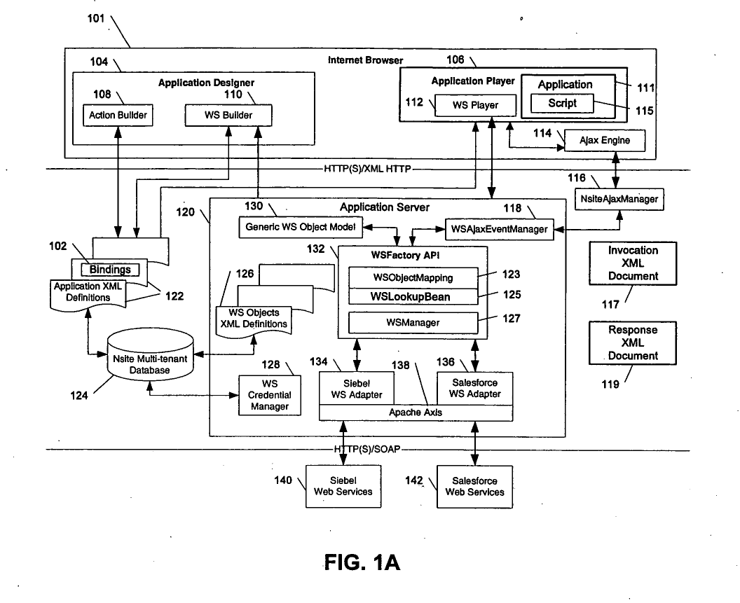

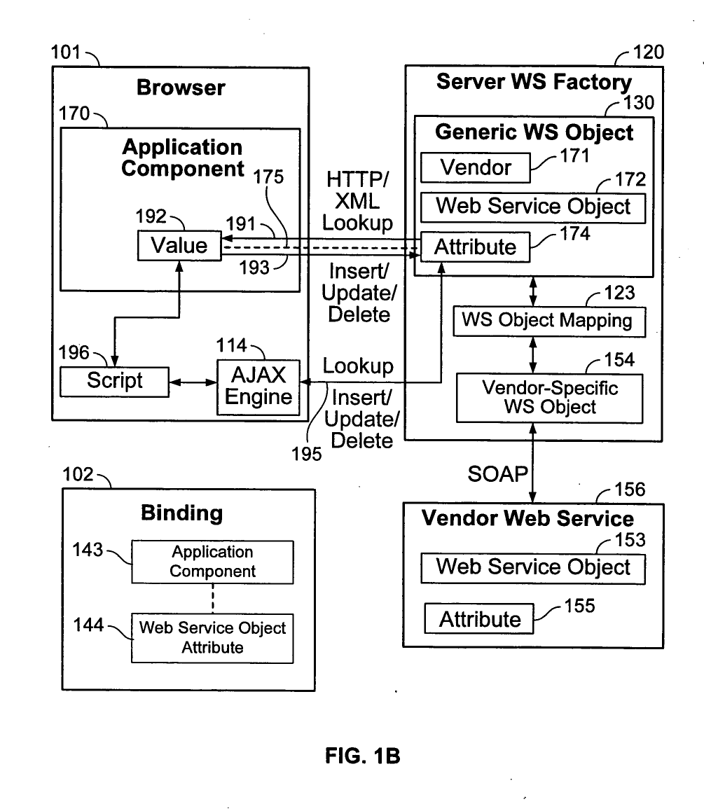

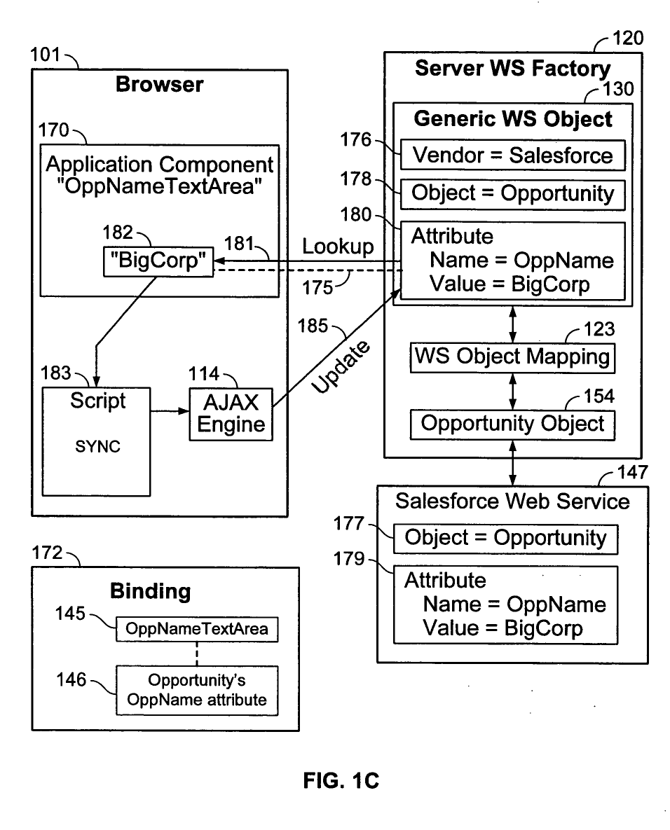

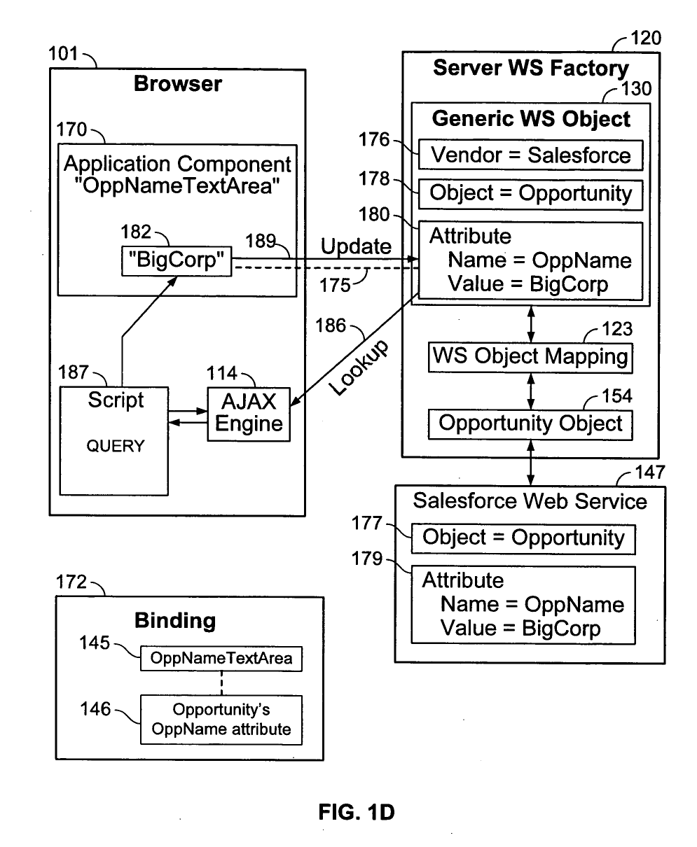

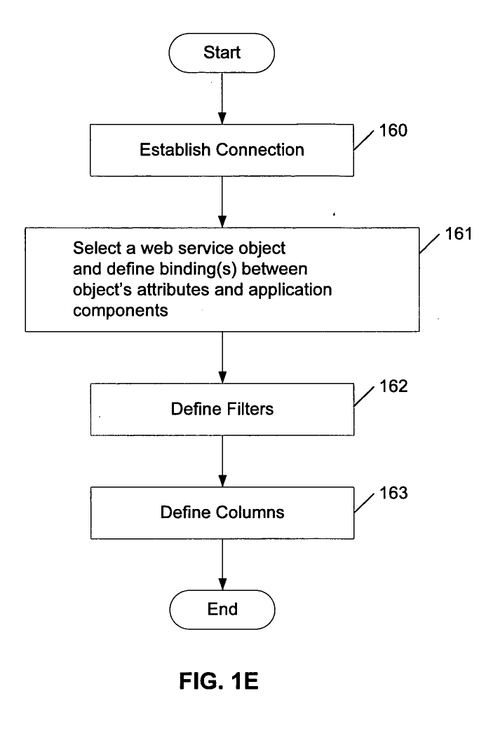

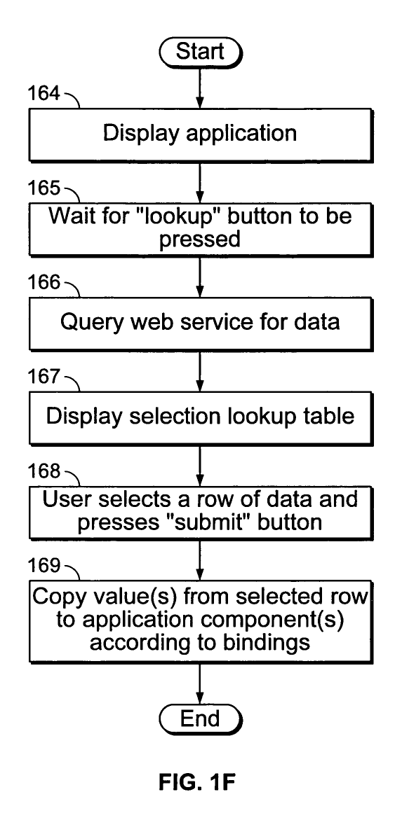

FIG. 1A is an illustrative drawing of a computer enabled system for developing and executing browser-based software applications. The system includes a Designer 104 and a Player 106, as described in the commonly owned Patent Application entitled “Browser Based Designer and Player,” referenced above. The Player 106 is a computer program that provides a user interface which executes a browser based application 111, which can receive values from web services, send values to web services, and invoke other operations provided by web services. An exemplary Siebel web service 140 and an exemplary Salesforce web service 142 are shown. The Designer 104 is a computer program that provides a user interface which allows a user to create the application 111. The Designer 104 and Player 106 execute in a conventional Internet Browser 101, which may be, for example, Microsoft Internet Explorer or Mozilla Firefox™. Each element or component shown in FIG. 1A is a software computer program entity to be executed on a computer.

The Designer 104 and Player 106 are provided to the Internet Browser 101 by a server 120 as web pages. The web pages may be, for example, Java Server Pages (JSP) or Java Server Faces (JSF) pages, and may include HTML and JavaScript™ code that implements the Designer 104 and Player 106. The server 120 may be, for example, an application server computer program such as JBoss® or the like. The server 120 communicates with the Internet Browser 101 via a network protocol, e.g., HyperText Transfer Protocol (HTTP) or Secure HyperText Transfer Protocol (HTTPs). The components shown in the server 120 typically share a single address space and communicate with each other via function calls. The components shown outside the server 120 typically communicate with the server via a network protocol, such as HTTP for the Internet Browser 101. Note that “server” here generally refers to software rather than to a physical computer.

Applications created by the Designer 104 are stored in Extensible Markup Language (XML) format as XML definitions 122 in a database 124, and loaded into the Player 106 as the application 111. The XML definitions are described in the aforementioned commonly-assigned patent application, and are described in more detail herein with respect to web services-related portions of applications. For the web services-based applications described herein, the XML definitions include bindings 102 which associate application components with web service object attributes.

The server 120 receives web service interaction requests from the Designer 104, e.g., a request for a list of objects provided by a web service, and interacts with web services provided by specific vendors, such as the Siebel Web Service 140 provided by Oracle Corporation of Redwood Shores, Calif., and the Salesforce Web Service 142 provided by Salesforce.com of San Francisco, Calif. The server 120 communicates with the web services via a network protocol, such as Simple Object Access Protocol (SOAP), which may be based on the HTTP or HTTPs protocol. The server 120 includes components implemented in a computer programming language, e.g., Java™, C#™, or the like.

The components of the server 120 include a Generic Web Service Object Model 130 (also referred to herein as a Genetic WS Object or a WSObject), and a Web Service Factory Application Programming Interface 132 (also referred to herein as a WSFactory API). The WSFactory API 132 includes a WSObjectMapping 123, which maps, i.e., converts, the Generic WS Object Model 130 (WSObject) to vendor-specific Application Programming Interfaces, such as a Siebel Web Service Adapter 134 for interacting with the Siebel Web Service 140, and a Salesforce Web Service Adapter 136 for interacting with the Salesforce Web Service 142. More specifically, the WSObjectMapping 123 generates the Generic WSObjects 130 for substantially all object types provided by a web service (e.g. an Opportunity object type that represents a sales opportunity). The mapping between the Generic WS Object Model 130 and the vendor-specific adapters, such as the Siebel WS (Web Services) Adapter 134, is represented as a WS Object XML definition 126, which is stored in the database 124. The WS Object XML definition 126 is also referred to herein as an XML mapping file and is described in more detail below.

The adapters, e.g., the Siebel WS Adapter 134, interact with the vendor specific objects 138 generated by, e.g., Apache Axis. Apache Axis is a programming tool available from the Apache Software Foundation. The vendor specific objects 138 are generated by a software tool, such as the Axis WSDL2Java command line tool, from vendor specific web service interface descriptions, as is known to those skilled in the art. The web service interface descriptions are typically provided by the web service vendor in a format such as WSDL.

The WSFactory API 132 includes a WSManager 127, which has functions for querying, inserting, updating, and deleting objects provided by web services. The functions provided by the WSManager 127 are shown in Table 1.

TABLE 1

| | |
|---|---|
| WSFactory Function | Description |
| queryObject | Get a list of instances of an object. |
| insertOrUpdateObject | Inserts or updates a specified instance with |
| | specified values. |
| deleteObject | Deletes a specified object. |

In the WSFactory API 132, web service data is represented as objects with attributes. In the user interfaces of the Designer 104 and Player 106, these objects are presented to the user as rows in a table. Each row has one or more columns, which correspond to the attributes of the object. For example, there could be an object named Opportunity with attributes named OpportunityName and OpportunityId. There could be any number of Opportunity object instances in the web service, and each Opportunity object would have an OpportunityName and OpportunityId. These objects can be retrieved by the queryObject method, created or updated by the insertOrUpdateObject method, and deleted by the deleteObject method.

The queryObject method supports filter and column restrictions. A user can specify a filter to reduce the number of objects returned in the query, and a set of columns to reduce the number of attributes in each object returned in the query. For example, a filter restriction could indicate that only Opportunity instances for which the name contains the value “BigCo” are to be returned in query results. A column restriction could indicate that only the OpportunityName column is to be returned in query results. The filters and column specifications can thereby reduce the quantity of data retrieved from the web service.

The WSFactory API 132 creates an instance of the WSManager 127 for each type of adapter. The WSManager 127 invokes the adapters, e.g., the Siebel Adapter 134 and the Salesforce adapter 136, to perform web service invocations in response to user requests. For example, when a user submits data values in an application, the WSManager 127 inserts into or updates the web service using the new values. As another example, when a user requests data in an application, the WS Manager 127 performs a lookup operation to query the web service for the data. The WSManager 127 may be invoked by the Designer 104, e.g., to get a list of web service objects, or by the Player 106, e.g., to submit or lookup data values. The WSManager 127 may also be invoked by a WSAjaxEventManager 118 to process requests from scripts, as described below with reference to AJAX.

The server 120 also includes a web services Credential Manager 128, which manages security information such as user names and passwords. The security information is provided by a user and is in turn provided by the server 120 to the web services, e.g. the Siebel Web Service 140, to authenticate the user.

A Web Services AJAX API and associated methods are provided for allowing scripts executed by the Internet Browser 101 to invoke server-side computer program code, such as the WSFactory API. The Web Services AJAX API is provided because the commonly-used HTTP request/response communication model for retrieving web pages does not allow a client, e.g., a script or web page executing in the Internet Browser 101, to invoke server-side logic at arbitrary times, without reloading the web page. However, such client invocations are useful because they allow a user to write scripts in a language such as JavaScript™ to customize the behavior of applications. The Web Services AJAX API allows users to write such scripts to customize application behavior by interacting with web services.

The Web Services AJAX API is based on the AJAX technique, which is known to those skilled in the art, for making asynchronous JavaScript invocations using XML between a browser and a web server. The asynchronous JavaScript invocations can be made at arbitrary times without requiring the web page displayed in the browser to be reloaded. In the AJAX-based invocation method, a script associated with an application component of the Application Player 106 can call programming interfaces of the server 120, such as the WSFactory API 132. For example, a user-defined script that is called when a button component is pressed can call the WSFactory API 132 to interact with web services, such as the Siebel web service 140 and the Salesforce web service 142. The Web Services AJAX API uses an AJAX Engine 114, which, as known to those skilled in the art, includes an XmlHttpRequest interface (not shown) that allows JavaScript code to send requests to and receive responses from a web server such as the server 120 without reloading, or changing the appearance of, the web page displayed in the Internet Browser 101. The AJAX Engine 114 communicates with an NsiteAjaxManager 116 by sending and receiving an invocation XML document 117 containing interaction requests and responses via an HTTP connection. The NsiteAjaxManager 116 receives and responds to HTTP requests and may be, for example, a Java™ servlet. The NsiteAjaxManager 116 invokes a WSAjaxEventManager 118 of the server 120 via in-process procedure calls to perform web service invocations such as lookups, inserts, updates, and deletions as specified in HTTP request messages received by the NsiteAjaxManager 116 from the AJAX Engine 114. The WSAjaxEventManager 118 in turn invokes the WSFactory API 132 to perform the requested web service interactions, and the WSFactory API 132 invokes the appropriate lookup, insert, update, or delete methods of the WSManager 127.

The invocation XML document 117 is an XML-format representation of a web service interaction, such as a lookup, insert, update, or delete of data in a web service object. The invocation XML document includes a method name and parameters, encoded in XML format, which are extracted by a servlet in the NsiteAjaxManager 116, and the NsiteAjaxManager 116 invokes the corresponding method of the WSManager 127 to perform the web service interaction specified in the invocation XML document 117. Upon completion of the interaction, the WSManager 127 returns a result to the NsiteAjaxManager 116, which encodes the results in a reply XML document 119. The reply XML document 119 is sent back to the AJAX Engine 114 as a reply. The XML documents are transmitted between the NsiteAj axMAnager 116 and the AJAX Engine 114 using an XmlHttpRequest component (not shown), which is provided by the Internet Browser 101.

The Designer 104 includes a web services builder 110, which is a computer program that provides a user interface for defining web services interactions in browser-based applications 111. The Player 106 executes browser-based applications 111, which have application user interface components, such as text fields, for receiving data values from a user. Examples of applications 111 include forms-based applications for entering information about a sales opportunity or, as another example, for scheduling a medical procedure in a hospital. A WS Player 112 component of the Player 106 allows applications executing in the Player 106 to interact with web services by, for example, looking up a value from a web service and storing the value in an application component associated with the application 111, or inserting, updating, or deleting a value in a web service object, where the value is specified by an application component. These web services interactions are performed according to bindings 102 defined by a user using the web services builder 110.

The web services builder 110 allows a user to define bindings 102 between components of the application, e.g. buttons and tables, and web service attributes, e.g. values that can be stored in or retrieved from web services. Note that this application-to-web-service binding is essentially a mapping between objects and so is conceptually similar to the WSObject-to-vendor-object mappings described above as WS Object XML definitions 126, but the two types of mappings are described separately herein for clarity. There is no requirement that the bindings 102 be represented using-the structures described herein. Other structures that represent the information contained in the bindings 102 could also be used. For example, the bindings 102 could all be represented by a single data structure.

FIG. 1B is an illustrative drawing of a binding between an application component and a web service according to one example. The binding 193 associates a value 192 of an application component 170 with an attribute 155 of a web service 156. The binding 193 is a two-way mapping which specifies that a particular web service attribute 155 can be set to the value 192 of the application component 170, and, conversely, that the value of the application component 170 can be set to the value of the attribute 155. The actual setting of these values occurs as part of a web service interaction such as a lookup, insert, update, delete, or user-defined interaction. The lookup interaction, which retrieves data from the web service 156, causes the value 192 of the application component 170 to be set to the value of the attribute 155. The insert and update operations, which send data to the web service 156, cause the value of the attribute 155 to be set to the value 192 of the application component. The delete interaction causes a specified web service object to be deleted from the web service. User-defined interactions, such as invocation of web service methods, can be performed by the script 196.

FIG. 1B illustrates the flow of data between an application component 170 and the web service 156 via the WS Factory 120 according to one example. As described above with reference to FIG. 1A, an application running in an Application Player 106, which is in turn running in the browser 101, interacts with the WS Factory 120 running in a server 120. The application includes at least one application component 170. The application component includes a value 192, which is displayed to a user and may be set by a user, e.g., as a value of a text box or of a drop-down list. The application component 170 may be associated with a script 196, which is part of the application. The script 196 includes user-defined computer program code in a programming language such~as JavaScript™ or the like. The script 196 can access, i.e., set and get, the value 192, as shown by the arrow between the script 196 and the value 192. The script can invoke the AJAX Engine 114 to perform web service interactions, such as setting and getting the value of a web service attribute 155 associated with a web service object 153 provided by a vendor web service 156. The vendor web service as stated above may be, for example, a web service provided by Siebel Systems Inc., an entity of Oracle Corporation of Redwood Shores, Calif., or by Salesforce.com of San Francisco, Calif. Each vendor web service 156 typically has a vendor-specific data model, e.g., a model based on sales opportunities in the Salesforce web service, but it is desirable to allow the Designer 104 and Player 106 applications to work with multiple web services, typically provided by different vendors, that have different data models. To allow the Designer 104 and Player 106 to be vendor-independent and work with multiple web services without the need for vendor-specific code in the Designer 104, the Player 106, or the Internet Browser 101, a Generic WS Object 130 is provided in the server 120. The Designer 104 and Player 106 use the Generic WS Object 130 to interact with the vendor web service 156, e.g., to set and get values of the vendor-specific attribute 155. The WS Factory 120 maps the generic WS Object interface 130 to a vendor-specific object 154, e.g., an Opportunity object generated by Axis from WSDL via a WSObjectMaping 123.

The bindings 102 can be defined and associated with an application by a user using the web services builder 110 to enable the application to set and get values of the attribute 155 of the web service object 153. Multiple bindings 102 can be associated with an application. In one aspect, a set of bindings 102 is associated with a user interface component, such as button or link, that, when selected by a user, causes a web service interaction such as a lookup or insert. A user defined script in a programming language such as JavaScript™ can also be associated with a user interface component. The user defined script can dynamically create bindings 102 while the application is running in the Player 106, and can invoke any type of web service interaction, including lookups, inserts, updates, and deletes. Data values will be transferred between the application components and web service attributes specified in the bindings 102, and the direction of data transfer will be determined by the user interface component or script that initiated the interaction.

The bindings 102 are represented in XML A binding between an application component and a web services object attribute is specified using XML: The XML element format for attribute bindings, column bindings, and filters is shown in Appendix D.

An attribute binding can be specified using a WSAttributeMapping XML element, which includes a formentity value that identifies the application component, and a wsattribute value that identifies the web service attribute bound to the application component. For example, Appendix D shows a WSAttributeMapping with a formentity=OppNameTextArea and a wsattribute=OppName, which means that the OppNameTextArea application component is bound to the OppName web service attribute. A list of multiple bindings can be specified as an XML WSAttributeBindingList, which is a list of WSAttributeMapping elements, each defining a binding.

A binding between a column of an application table and a web services object can be specified using a WSLookupTableColumn XML element, which includes a wsobjattribute that identifies the web service attribute bound to a table column, and a label that specifies a name for the column. For example, Appendix D shows a WSLookupTableColumn element with a wsobjattribute=OppName and a label=Name, which means that the OppName attribute is bound to a table column that corresponds to the WSLookupTableColumn element, and the table column's name is Name. A list of multiple column bindings can be specified as a WSTableBindingList, which is a list of WSLookupTableColumn elements, each defining a binding.

As introduced above with reference to the WSFactory API 132, a filter can be defined to reduce the quantity of data to be retrieved from a web service. A filter can be specified as a WSFilterField element, which includes a filterfieldwsattribute that specifies a web service attribute, an optional formentity that specifies an associated application component, and a filterfieldtype that specifies the type of filter, e.g., attribute-based or condition-based. Condition-based filters are specified using logical conditions similar to those used in where clauses in the well-known Structured Query Language (SQL). An attribute-based filter specifies an attribute of the web service for which filtering can be performed by a user of the WS Player 112. For example, Appendix D shows a WSFilterFeild element which includes a filterfieldwsattribute=OppName, which means that filtering is to be applied to lookups so that a user of the WS Player 112 can restrict the web services objects that will be retrieved to those for which the OppName attribute has a specified filtering value. The WSFilterField element also includes a filterfieldtype=Dropdown, which means that the attribute filter will appear as a drop-down menu in the WS Player 112. The drop-down menu will include a list of possible values for the OppName attribute, and the user will be able to select a value from the drop-down menu to use as the filtering value. A user of the WS Player 112 can then select a value from the drop-down menu to cause the WS Player 112 to retrieve objects for which the corresponding attribute is equal to the selected value from the web service.

The bindings 102 are used by the WS Player 112 when a web service interaction is performed, e.g., in response to a user selecting a web services trigger component, such as a button, in the WS Player 112, as follows. When a lookup interaction is performed, e.g., in response to a user of an application 111 running in the WS Player 112 pressing a button for which bindings 102 have been defined using the WS Builder 110, the bindings 102 associated with the application component are executed by setting the value of each bound application component to the value of the corresponding attribute., where the corresponding attribute is specified in the binding.

When an insert or update interaction is performed, e.g., when a user submits an application page that includes data to be saved to the web service, the bindings 102 of the application are executed by setting the value of each bound attribute the value of the corresponding application component., where the corresponding application component is specified in the binding.

There is also a synchronize interaction, which is a combination of the insert or update interaction and a delete interaction. When a synchronize interaction is performed, e.g., when a user clicks a button that is associated with a script that invokes a synchronize operation, the bindings 102 of the application 111 are executed as shown by the pseudo code representation in Table 2.

TABLE 2

for each binding in the application,

if the binding is for an application table then

for each row in the application table

if the current row is bound to an existing

web service object and the attributes have been changed in the
application table then

update the existing web service object

with the new attributes

end if
if the current row is new then

insert a new web service object with

the column values in the application table

end if
if a row has been deleted from the

application table then

delete the corresponding web service

object

end if

end if
if the binding is for a group of components then

update the corresponding web service object with the

new attributes from the group of components

end if

end for

FIG. 1B shows how data is transferred between the application component 170 and the vendor web service 156. A value 192 of the application component 170 can be retrieved from the web service 156 by a lookup interaction, as shown by the arrow 191 from the attribute 174 of the Generic WS Object 130. The mapping 175 specifies that the value of the attribute 174 can be transferred or copied to the application component value 192 when a lookup operation is performed. The lookup operation can be invoked by the WS Player 112 in response to a user request. The lookup operation can also be invoked by a user-defined script 196 at any time during execution of the application. Conversely, the mapping 175 also specifies that the value 192 can be copied to the attribute 174 when an insert or update operation is performed. As with the lookup operation, the insert or update operation can be invoked by the WS Player 112 in response to a user request. The insert or update operation can also be invoked by the user-defined script 196 at any time during execution of the application.

A binding 175 associates a text area component of an application with a Name attribute of a Sales Opportunity web service object. A user of the application player 106 can lookup values for the application component (e.g., the text area), from the associated web service attribute, as well as insert the application component's value into the web service attribute and delete a value from the web service. Those web services interactions can be defined using the web services builder 110 of the application designer 104, typically by using the web service builder 110 to associate web service bindings 175 with a button component of the application 111. The web services builder 110 can be used to bind an application component to an attribute of a web service, and specify whether the interaction type is lookup, insert, modify, or delete. Users can define additional types of interactions by providing a script 115 to be executed as a computer program as part of the application 111. The script may include, for example, code in the JavaScript™ language. The script 115 is associated with a component (not shown), e.g., a user interface component, of the application 111, and can access the values of application components. The script can also invoke web services, as described elsewhere herein.

FIG. 1C is an illustrative drawing of an example binding 175 and interactions between an application component and a web service. A lookup 181 is performed in response to a user's request, e.g., a user pressing a Search button, followed by an update 185 performed by a script 183 which invokes a SyncManager(“SYNCHRONIZE”) call. Note that other combinations are possible. This combination is shown as an illustration. In general, as shown in FIG. 1B, a lookup can be invoked by either a user action or a script, and an insert or update can be invoked by either a user action or a script. This figure shows a lookup 181 invoked by a user action, followed by an update 185 invoked by a script 183. The lookup 181 transfers data from the web service 147 to the application component 170, and the update 185 transfers data in the opposite direction. A binding description 172 is also shown. The binding description 172 illustrates that the binding 175 is represented as an association between a component 145, named OppNameTextArea, and a web service attribute 146, named OppName.

FIG. 1D is an illustrative drawing of an example binding and interactions between an application component and a web service. FIG. 1D shows the combination of a lookup 186 performed by a script 187 which invokes a SyncManager(“QUERY”) call, and an update 189 performed in response to a user action, e.g., a user pressing a Submit button. The lookup 186 retrieves the value 182 of the application component 170 from the Generic WS Object 130 identified by the binding 175. The update 189 sets the value of the attribute 180 of the Generic WS Object 130 to the value of the value 182 of the application component 170.

For lookup interactions, when an application is executed in the Player 106, a user may press a button component previously associated with a web service binding to query the web service and display a list of one or more values returned by the web service according to the binding. The user can then select a value from the list, and the selected value will appear in the corresponding application component. The list of values is referred to herein as a Selection Lookup Table.

A web service object, such as the Sales Opportunity object, may have multiple instances, e.g., multiple sales opportunities, in which case a user may select one or more instances in the application player 106 as the values to be used for the application. Filters can be defined in the web services builder (typically after defining the bindings), to restrict the displayed instances of a web service object to a subset of all instances according to a condition. For example, a filter may restrict the sales opportunities to be displayed to those in a specific country by specifying a specific value for a country attribute. The set of attributes to be displayed in the Selection Lookup Table can also be restricted to a subset of all attributes by defining specific columns to be displayed. For example, the country attribute could be excluded from the attributes displayed by excluding the country column in the web services builder.

The WS Player 112 uses binding information that establishes a mapping between WS object attributes and application components to display a Web Service lookup user interface for storing or retrieving the values of those components to or from web services. The binding information is stored in the Application XML Definitions 122.

The web services player 112 is launched by the application player 106 when a user clicks on a component that has been configured to invoke a web service by the web services builder 110. Components that can be configured to invoke a web service include button components and area components. The WS Player 112 uses the information stored in the WSBuilderObject to render its own user interface components. The WS Player 112 presents a Selection Lookup Table user interface component, which allows a user to select any number of data rows returned from a Web Service. The selected rows will be passed to the WS Player 112, and, in one example, included in application user interface components which have been previously bound to the Web Service.

One approach to invoking the web service object would be to call vendor-specific objects directly from applications. That approach requires the application to know details about each vendor specific object, and ties the application to a particular web services vendor. Therefore a generic web services object is introduced. Each vendor-specific object is mapped to the generic web services object by a definition stored in an XML mapping file. Applications interact with the generic web services object and need not contain hard-coded dependencies on vendor specific objects.

The generic web services object is represented in the Java™ programming language by the WSObject class. Note that although the Java™ language is used in this description, any programming language may be used to implement the features described herein. The WSObject class represents each attribute of a vendor-specific Web Service object as a vendor-independent generic object. An instance of the WSObject class can includes an arbitrary number of fields, which are stored in a list. A pseudocode definition of the structure of the WSObject class is shown in Table 3.

TABLE 3

public class WSObject {

| | |
|---|---|
| public String Vendor; | // Web Service vendor name |

| | |
|---|---|
| public String objectName; | // Web Service object name |
| public String xmlMapping; | // xml mapping for WS object |
| public ArrayList object; | // list of object fields |

public Object getFieldValue(String fieldName) {......}

}

The getFieldValue method returns the value of a field (also referred to herein as an attribute), where the field is specified by a field name. The WSObject's Vendor attribute is set to the vendor name, and the WSObject's objectName attribute is set to the vendor-specific object name. Each vendor-specific object is mapped to a corresponding generic web services object by defining a mapping (also referred to herein as a binding) which maps each attribute in the vendor specific object to a corresponding field in the generic web services object. The binding is represented as an XML mapping document. The xmlMapping attribute of a WSObject contains the XML mapping document for that WSObject. A WSObject has all the information needed to represent a vendor specific object's attribute names and values.

A Generic WS Objects 130 is created by a WSFactory 132 based on a URL supplied to the WS Factory 132. The URL refers to a web service provided by a particular vendor, such as a Siebel Web Service 140 or a Salesforce Web Service 142. The WSFactory 132 retrieves objects from the web service via a communication protocol such as SOAP (Simple Object Access Protocol) over HTTP (HyperText Transfer Protocol). The WSFactory 132 uses an Apache Axis interface library or the like to read the objects, and uses-a vendor-specific adapter such as a Siebel WS Adapter 134 or a Salesforce WS Adapter 136 to create the Generic WSObject(s) 130 that corresponds to the objects read from the web service, e.g. the Siebel Web Service 140. The Adapter objects include vendor-specific types and functions for accessing the vendor-specific web services. The Generic WS Objects 130 provide a generic object model which does not have any vendor-specific types or functions. Instead, the names and types of vendor-specific web services attributes are represented in the WS as data, particularly as XML data. Therefore, applications such as the Designer 104 and the Player 106 can interact with a web service from any vendor without modification of the applications themselves. For example, if a third vendor Web Service, e.g., an Oracle Web Service (not shown) were available, then the existing Designer 104 and Player 106 would be able to interact with the Oracle Web Service if an Oracle WS Adapter (not shown) were added between the WSFactory 132 and the Apache Axis 138.

The most common form of interactions between applications in the browser 101 and web services such as Siebel web services 140 is the interaction through the Generic WSObjects 130 and the WSFactory 132 as described above. Those interactions can be implemented for common uses of application components, e.g. getting and setting data values, by the Designer 104 and Player 106, in which case the user defines the interactions using the Application Designer 104. However, it is also desirable to allow users to define program scripts, i.e., code logic, as part of the applications to perform custom behavior, and to allow that logic to invoke web services. User-defined scripts can invoke web services using an AJAX-based API (application programming interface). The user defines such scripts by associating script code with application components using an action builder portion (not shown) of the Designer 104. As introduced above, the AJAX-based API passes web services invocations from the browser 101 to the WSFactory API 132 via an AJAX Engine 114 embedded in the browser 101, an NsiteAjaxManager 116 that communicates with the AJAX Engirie 114, and a WSAj axEventManager 118 which is included in the WSFactory 120 and communicates with the NsiteAjaxManager 116. The AJAX-based API also receives responses from web services invocations from the WSFactory. These web services invocations and responses are passed between the AJAX-based API and the WSFactory as data in an XML format. The XML format is shown in Appendix B, and an example of an XML document passed via AJAX is shown in Appendix C.

A web service invocation can also be made from the Internet Browser 101 by a call embedded in the web page, e.g. a Java™ language call embedded in a Java™ Server Page (JSP) that provides the application player 106. Such an invocation is included in the web page sent by the server to the Internet Browser 101

For example, consider a mapping between an exemplary vendor specific Account object and a generic WSObject. The exemplary vendor-specific Account object has a Name attribute and a LastModifiedDate attribute. A Java™ class definition representing the exemplary vendor-specific Account object is shown in Table 4.

TABLE 4

public class Account {

java.lang.String Name;
java.util.Calendar LastModifiedDate;

}

The XML mapping file defines a mapping between each attribute of a generic class such as the Account class shown above, and a class or classes in the specific web service vendor's interface. For example, for the Account class shown above, the XML mapping file defines a mapping between the generic Account class and a vendor-specific class named com.aspecificvendor.soap.enterprise.object.Account. The XML mapping file also defines a mapping between each attribute of the generic class and an attribute of the vendor specific class or classes. For example, the Name attribute of the generic Account class is mapped to an attribute named object0 of the vendor specific class. The XML Mapping for the Account object is shown in Table 5.

TABLE 5
<?xml version=“1.0” encoding=“UTF-8”?>
<WSObjectMapping xmlns:xsi=“http://www.w3.org/2001/XMLSchema-
instance” xsi:noNamespaceSchemaLocation=“WSMapping.xsd”
wsvendorname=“ASpecificVendor”
wsobjectname=“com.aspecificvendor.soap.enterprise.object.Account” >

<WSAttributeMapping wsattributename=“Name”

wsattributetype=“java.lang.String” wsobjectattributename=“object0”
/>

<WSAttributeMapping wsattributename=“LastModifiedDate”

wsattributetype=“java.util.Calendar”
wsobjectattributename=“object3” />
</WSObjectMapping>

The Designer 104 uses the XML file to decide the meaning of attributes for the generic WS object. The XML mapping file can be generated automatically from the vendor specific WS object and WSDL definition by using a program named WSFactory.

The mapping between generic objects and specific web service vendor objects allows the Player 106 to query a vendor specific object for records, i.e., rows of data, or object instances. A function named getWSMapping is defined internally for querying vendor specific objects for all records. The getWSMapping function takes a vendor name, an object name, and a WSManager as parameters, as follows:
public List getWSMapping(Connection con, String vendorName, String objectName, WSManager wsManager)

The getWSMapping function returns a list of WSObject objects. Each vendor specific object returned from the web service call is mapped into a WSObject and put in a list and returned to the caller. If an attribute in a vendor specific object is another vendor specific object then the child vendor specific object is mapped into a generic WSObject and assigned to the corresponding attribute in the parent WSObject to form a nested WSObject.

Now consider the vendor-specific Account object mentioned above. A vendor-specific Account object returned by a web service call will be mapped to a WSObject object that contains values as shown in Table 6.

TABLE 6

| Data Member | Value |
|---|---|
| Vendor | A vendor name. |
| objectName | A name for the object. For example, |
| | com.aspecificvendor.soap.enterprise.object.Account |
| xmlMapping | the xml mapping file for the object |
| object[0] | A String object with the value of the Name |
| | attribute from Account object |
| object[1] | A calendar object with the value of the |
| | LastModifiedDate attribute from Account object |

The structure of the XML mapping file is described by the XML schema shown in Appendix A. As specified by the schema, the WSObject definition includes a set of WSObjectMapping and WSAttributeMapping XML elements.

The WS Player 106 has four user interface sections, which are an Authentication Section, a Filter Fields section, a Lookup Table section, and a Pagination section.

In the Authentication section, the user enters login credentials such as username, password and the Web Service URL, which is an Internet address of a web service. The user will be authenticated against the Web Service vendor with the login credentials. The filter fields and the lookup columns will be displayed only if the authentication is successful, i.e. the Web Service vendor accepts the logic credentials as valid.

The Filter Fields section defines filter fields based on which Web Service objects will be queried. Filter Fields allow the user to narrow the result set if the number of web services objects is too large. The filter fields also include custom fields.

The Filter Fields section is constructed from values selected by the user. The user can select values for filter fields from a list of values, or alternatively enter filter values in text boxes. The lookup data retrieved from the Web Service will be filtered so that only data matching the filter fields is displayed in the Selection Lookup Table of the Player 106. If multiple filter fields are selected, the query string will be an AND expression of the selected filter fields. If the user does not select any value for a filter field, that field will not be included in the search query.

The lookup table section will be constructed from the values selected by the user in step 4 in the WSBuilder. The first column in the table will be a checkbox which will allow the user to select the rows to be inserted into the application. Then all the columns selected by the user in the WSBuilder are displayed. If all the columns do not fit into the page then horizontal scrolling is used. If the WS Player 112 is launched from a Button or Link then the user can select only ibe row from the table and the data from that row will be used to populate the fields in application. If WS Player 112 is launched from a table then the user can select multiple rows and the table in the application will be populated with the values from selected rows. If a lookup column is selected as sortable in the WSBuilder then the result set can be sorted by that column.

When the query is complete we will be returning a generic a list of WSObject to the WS Player 112. The WS Player 112 will use the WSObject and the XMLMapping file for the corresponding object to populate the lookup table.

In the web service lookup table, a number of records will be displayed per page. After the lookup table the page numbers and page navigation links are displayed. Information about the current rows and the current page number are displayed on the left side. For example the string will be “Displaying 1 to 10 of 20 Products. Page 1/2”. The navigation links are displayed on the right side such as “First Previous 1 2 3 n Next Last”. A lazy fetch method is used to retrieve the data from the WS server so that performance is not affected. When the last page of the current result set is reached a new web service call is made to get the next batch of result set data.

A web service vendor may have a size attribute which indicates the total number of records that will be returned by the query. This attribute can be used to find out the total number of pages that the result set will occupy. For example if the query returns 125 records and the display size is 10 records per page, then there will be 13 pages. The number of records returned by the query can be controlled by the attribute batchsize. After the end of the current result set, a subsequent call to a query method returns the next result set.

If the web service vendor does not have an attribute which indicates the total number of records that will be returned by the query, then the WS Player 112 will not display a “Last” link in the navigation section for that vendor. The query method has a parameter called startRowNum which determines which result set will be fetched.

There are two types of Web service lookups. The first type of lookup retrieves, updates, or inserts at most one row of data from a web service, e.g. a set of attributes for a single object instance. The first type of lookup is referred to herein as a header lookup and is typically associated with a component, such as a Button, in the application. In the Player 106, a Selection Lookup Table for a header lookup can be displayed by clicking a Web Service builder link that appears in the component properties panel. In the Selection Lookup Table of the Player 106, only a single row of data can be selected for a header lookup.

The second type of lookup retrieves, updates, or inserts any number of rows of data from a web service, e.g. sets of attributes for multiple object instances. The second type of lookup is referred to herein as a table lookup and is typically associated with an area that has a table. In the Player 106, a Selection Lookup Table for a table lookup can be displayed by clicking on a Web Service builder link that appears in the area properties panel.

FIG. 1E is an illustrative drawing of a flowchart of a process for defining a binding and a lookup between an application and a web service. The web services builder 110 of FIG. 1A leads a user through this process. The process begins at block 160 by establishing a connection to a web service, e.g. to a Siebel or SAP web service. Next, at block 161, the user selects a particular web service object and defines bindings. When a user selects an object, the web services builder 110 displays a list of attributes for the object and allows the user to define bindings between the attributes and components of the application. The binding specifies how an application interacts with the web service as described elsewhere herein. At block 162, the web services builder 110 allows the user to define filters which restrict the data that will be displayed when the lookup is performed in the WS Player 112. A web service object,may have a large quantity of data, and the filters reduce the quantity of data presented to a user to simplify the task of selecting an appropriate data value for an application component in the WS Player 112. Finally, at block 163, the web services builder 110 allows the user to define which columns, i.e., attributes of web service objects, will be retrieved when a lookup is performed in the WS Player 112.

The steps of the process of establishing a binding are described individually in more detail below.

FIG. 1F is an illustrative drawing of a flowchart of a process for defining a web service lookup in an application player. The WS Player 112 of FIG. 1A leads a user through this process. The process begins at block 164 by displaying the application, which corresponds to the application 111 of FIG. 1A. At block 165, the process waits for the user to press a lookup button to retrieve data from a web service. The lookup button, bindings, data filter conditions, and specific columns of interest that will be used to retrieve data were previously added to the application by the user (or by a different user) using the Designer 104. After the lookup button has been pressed, block 166 queries the web service for data as specified by the bindings, filters, and columns. At block 167, a Selection Lookup Table is displayed. The Selection Lookup Table displays the data returned from the web service query as a set of rows and columns. Each column corresponds to an attribute of the web service object specified in the bindings and included in the columns of interest, and each row corresponds to an instance of the web service object, where the attributes of the instance meet the filter conditions, if filter conditions are present. At block 168, the user selects one or more rows of data and presses a submit button. At block 169, the selected row or rows are transferred to corresponding application components according to the bindings to fill in the application fields with data from the web service.

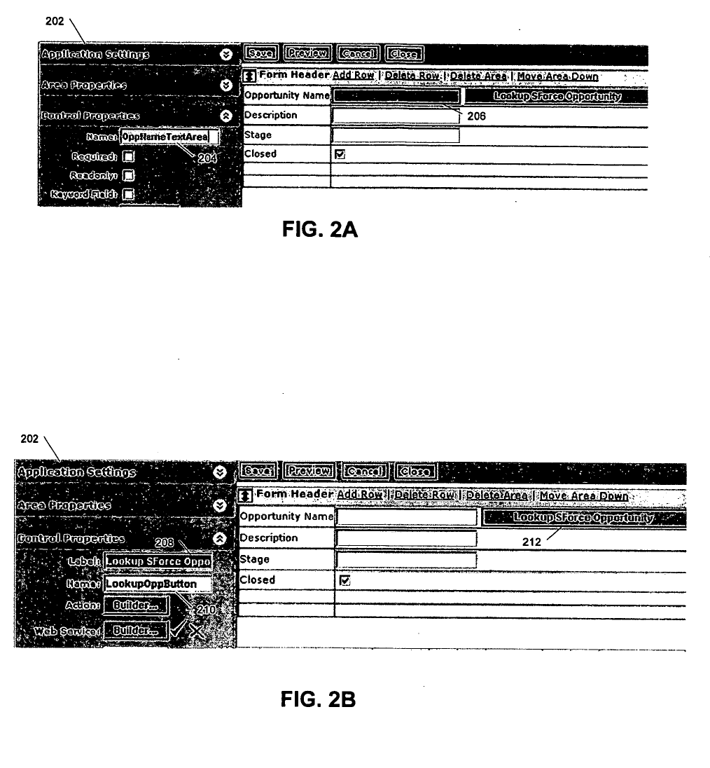

FIGS. 2A-15 illustrate user interface screens displayed in a web browser defining a header lookup. These screens, like all exemplary screens shown herein, are presented to the user on a computer display that allows the user to interact with the screens.

FIG. 2A is an illustrative drawing of defining an application component in an application Designer. The Designer 202 corresponds to the Designer 104 of FIG. 1A. The Designer 202 includes a web services builder interface, which corresponds to the web services builder 110 of FIG. 1A. The Designer 202 is being used to create an application component 206 of an application. The application component 206 is a text input component and has an associated name 204, OppNameTextArea.

FIG. 2B is an illustrative drawing of defining an application button component in an application Designer. The button component 212 is labeled Lookup SForce Opportunity. When the button 212 is pressed by a user in the application Player, a script associated with the button by an action builder is executed. The script may perform a web services interaction, such as a lookup, insert, update, or delete.

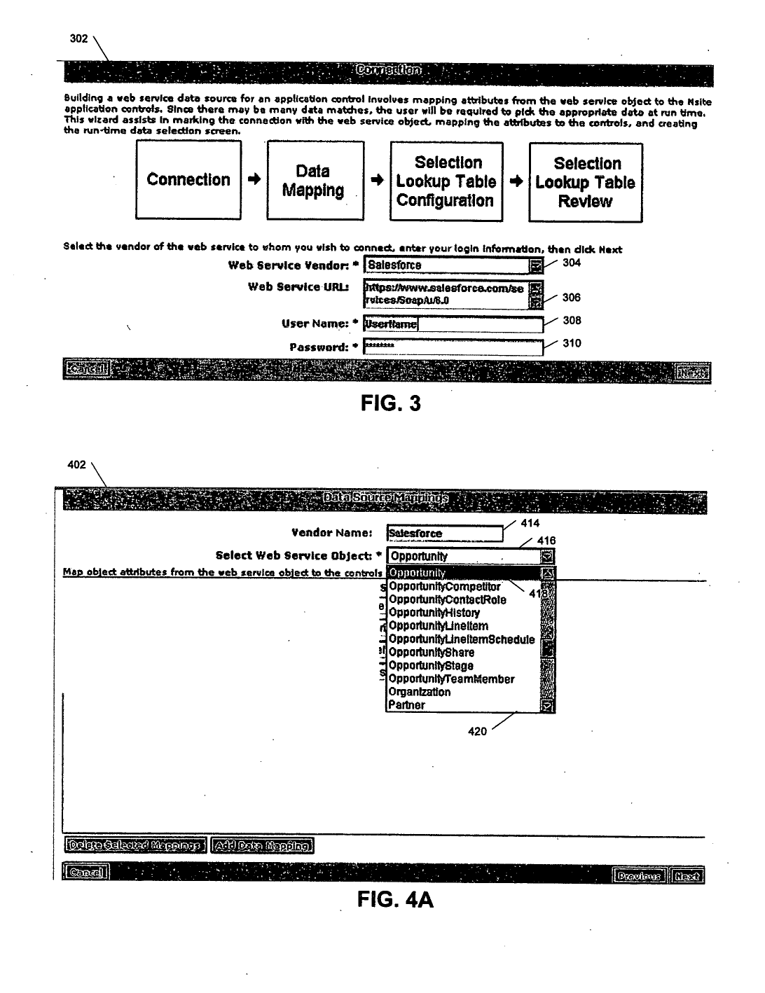

FIG. 3 is an illustrative drawing of defining a web service connection in an application Designer. A Connection screen 302 of a web services builder is shown, which allows a user to define parameters for communicating with a web service, including a vendor 304 of the web service, a URL 306 of the web service, and a user name 308 and a password 310 for logging in to the web service.

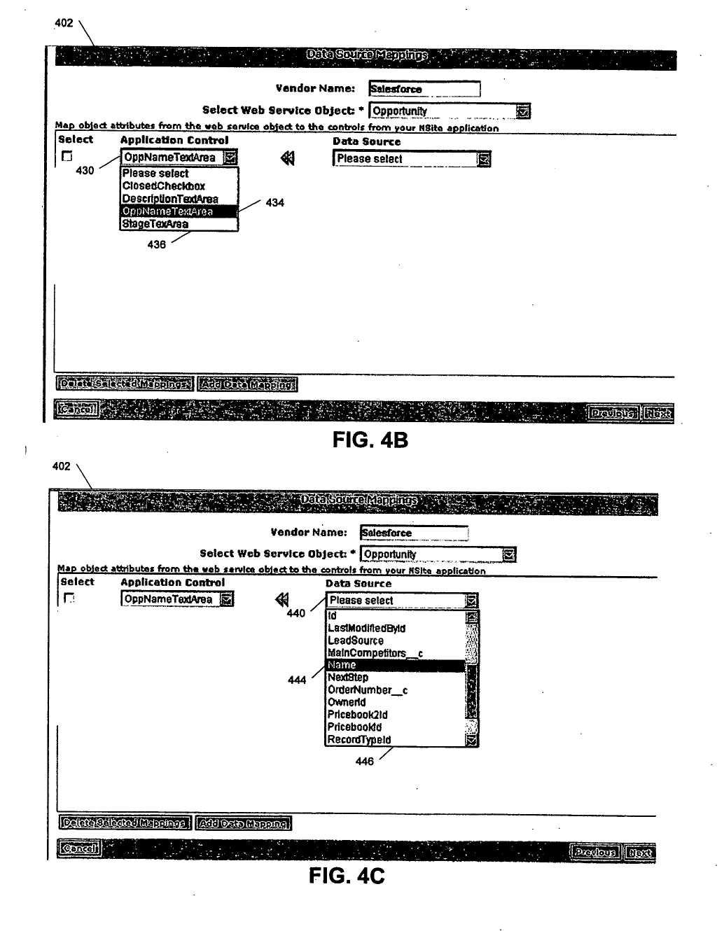

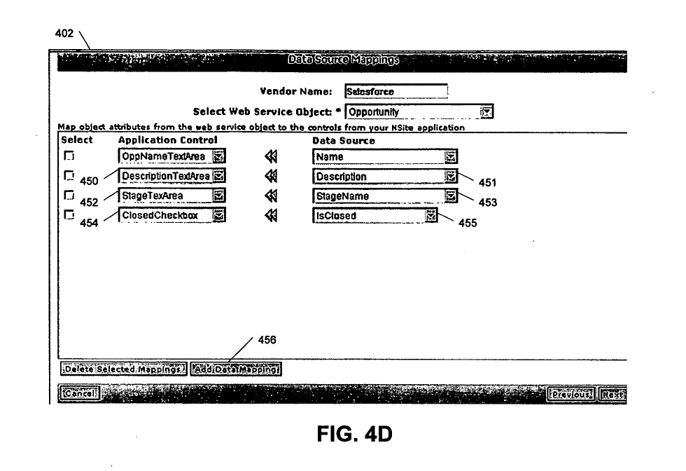

FIGS. 4A-4D are illustrative drawings of binding an application component in a web services builder. With reference to FIG. 4A, the application can bind an application component to a web service to perform any type of operation provided by the web service. In particular, an application component can perform Query, Update, Insert, Delete, and other types of operations on web services. Query, Update, Insert, and Delete operations can be specified using the web services builder. The Data Source Mappings screen 402 shows a vendor name 414, which is the vendor selected in the previous screen (i.e., the vendor 304 of FIG. 3), and also includes a web services object selection menu 420, which allows a user to choose a selected web service object 416. An Opportunity object 418 has been selected by the user. The selected object 416 will be used in the next screen to establish bindings.

FIG. 4B shows a data binding screen 402, which allows a user to establish bindings between application components (also referred to herein as controls), and attributes of the selected web service object 416 that was selected in the screen of FIG. 4B. The bindings correspond to the bindings 102 of FIG. 1A. The data binding screen 402 includes a set of application component-to-data source bindings. An application component selector 436 is displayed for each application component. A user can choose an application component 420 from the selector 436, which includes a list of components of the application.

FIG. 4C shows a web service attribute selector 446 of the data binding screen 402. The web service attribute selector is associated with the application component selector 436. A binding is created by selecting an application component and a web service attribute using the application component selector 430 and the web service attribute selector 440, respectively. Note that the web service attribute is referred to as a Data Source in FIG. 4C. Once an application component and web service attribute have been selected, a binding that links the component to the attribute can be added to the application by pressing an Add Data Mapping button. After the Add Data Mapping button has been pressed, another row having another application component selector and corresponding attribute selector will appear in the data binding screen 402 to allow the user to define another binding. In this way, a set of bindings 102 can be associated with an application XML definition 122.

The bindings can be executed in a web services Player 112. For Query operations, the web services Player 112 includes a “Vendor Selection” field, which allows a user of to select a vendor from a pull down list (e.g. Siebel® or Salesforce.com®), and an “Object Selection” field, which allows a user to select a WS object from a list of WS objects based on the selected vendor. The web services Player 112 then displays a Selection Lookup Table showing a list of selected web services object instances. The table typically contains at least three columns (e.g., object_id, meaningful_column1, meaningful_column2). The user can select two meaningful columns for a given web services object to display, and supply values for those columns to form key/value pairs. By default, if the key/value pairs are empty, all instances of the selected web services object will be retrieved from the web service. If the user specifies one or more key/value pairs, a subset of all instances of the selected web services object will be retrieved from the web service and presented in the Selection Lookup Table by the Player 106.

For Update operations, the user can start with an existing Selection Lookup Table presented as a query result. The name and/or description fields can be made editable, and new columns can be added at the end of the Selection Lookup Table by pressing an update button. In this way, the user can query a web service to generate a list of objects, make changes to the name and/or description fields in the list, and then click the update button to store and commit the changes to the web service. A subsequent query will return the updated values.

For Insert operations, there is an Insert button in the user interface of the web services Player 112. When the Insert button clicked, the user interface will display required fields as editable for the selected objects in one row, and the last field will be an Insert button which can be pressed to actually insert the current values of the fields in the appropriate web service object.

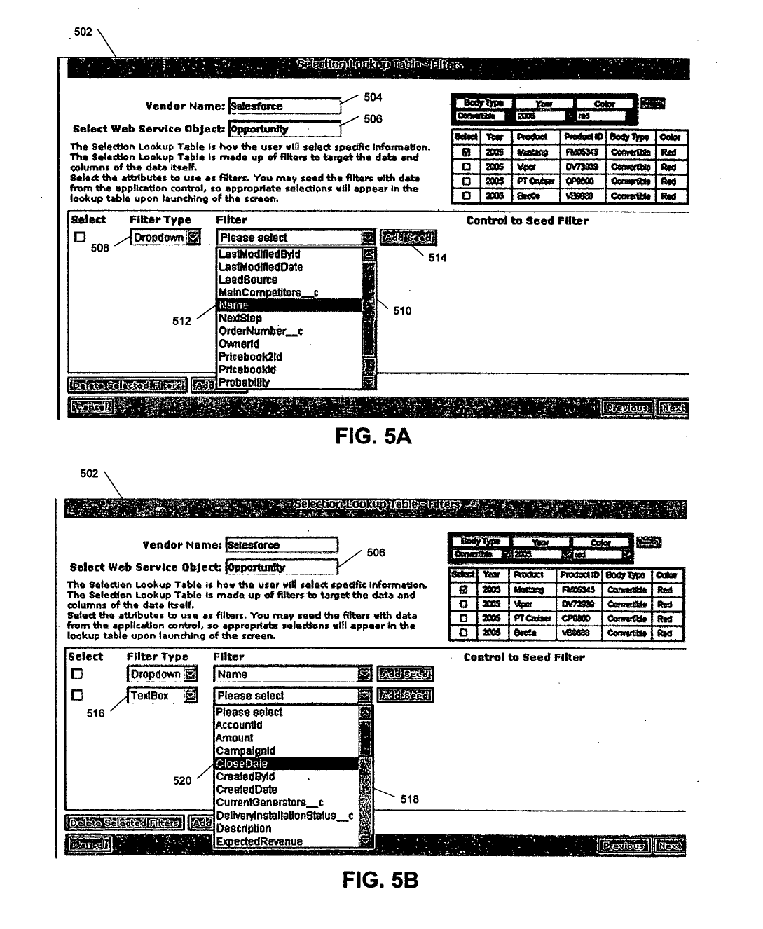

FIGS. 5A-5B are illustrative drawings of adding filters in a web services Designer when defining a Selection Lookup Table. FIG. 5A shows a web services builder filter definition screen 502 with a single filter definition, which includes a filter type 508 (Dropdown) and a filter value 512 (Name). A Dropdown filter with the value Name allows a user of the web services Player 112 to restrict the results of a web services lookup (as displayed in a Selection Lookup Table) to include only web services objects that have a Name attribute equal to a value that the user selects from a list of choices presented in a Dropdown list in the web services Player 112. FIG. 5B shows a second filter definition being added, with a filter type 516 (TextBox) and a filter value 520 (CloseDate). A TextBox filter with the value CloseDate allows a user of the web services player 112 to restrict the results of a web services lookup to include only objects that have a CloseDate attribute equal to a value that the user specifies in a text box in the web services Player 112.

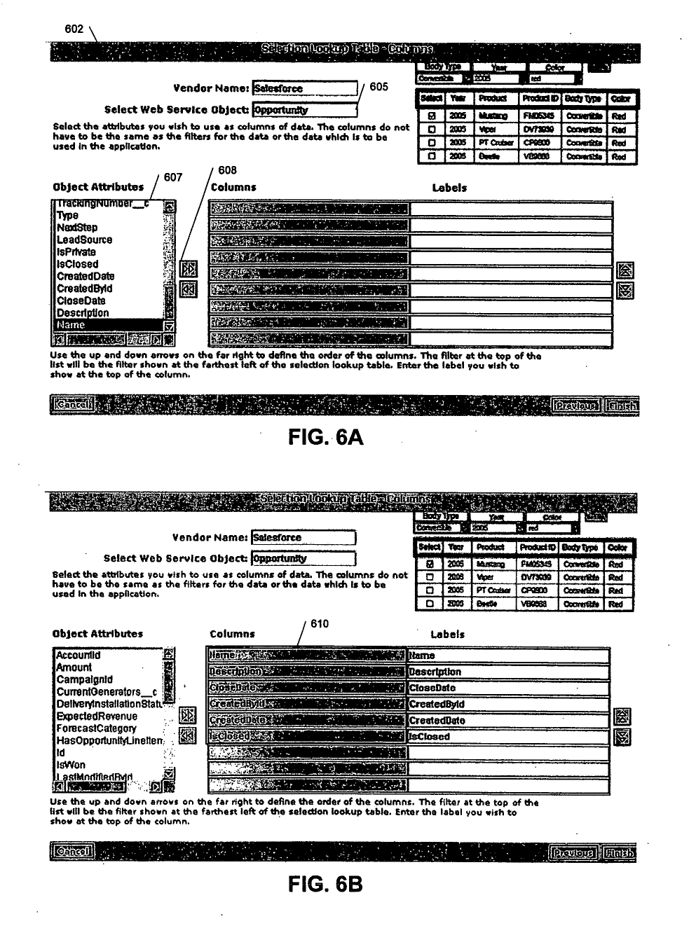

FIGS. 6A-6B are illustrative drawings of adding columns in a web services Designer when defining a Selection Lookup Table. FIG. 6A shows a web services builder column definition screen 602. The screen 602 allows a user to select columns from the column list 607 by pressing a button 606. FIG. 6B shows a list of selected columns 610, which includes the columns Name, Description, CloseDate, CreatedById, CreatedDate, and IsClosed. Each column has an associated label, which is a text string that will be displayed for the column in the Selection Lookup Table. Only values for web services attributes that are associated with the selected columns will be retrieved from the web service when a web service lookup is performed-in the Selection Lookup Screen.

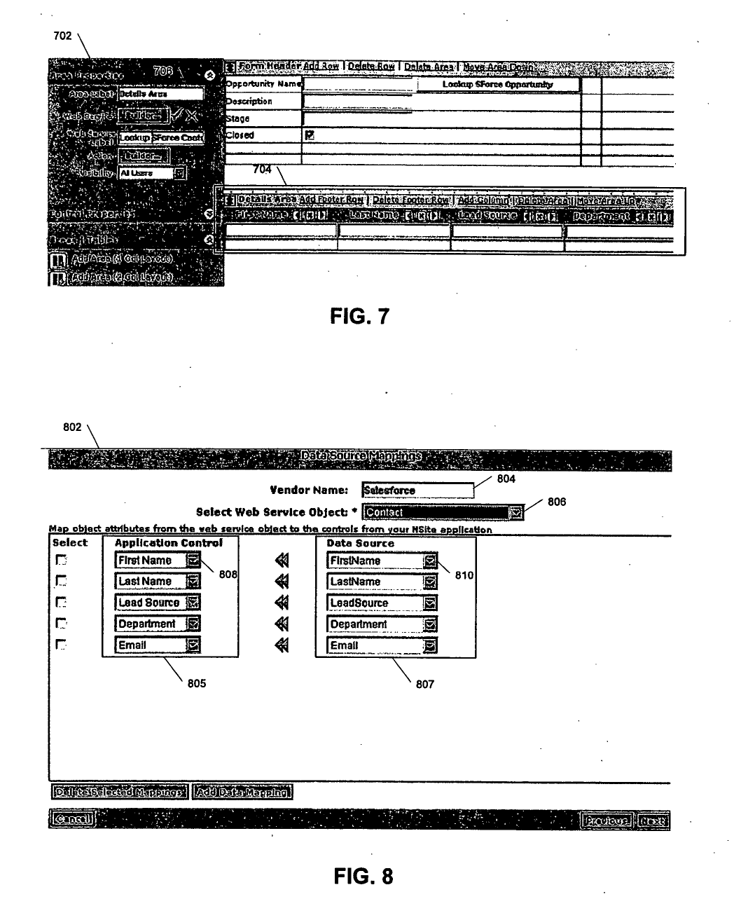

FIG. 7 is an illustrative drawing of defining a table area in an Application Designer. The application Designer 702 includes a table area 704, in which each column can be associated with a web service attribute.

FIG. 8 is an illustrative drawing of binding application table columns in a web services Designer. A data source mappings screen 802 of the web services builder is shown. The Data Source Mappings screen 802 is similar to the Data Source Mappings screen 402 of FIGS. 4A-4D. The screen 402 is used for defining bindings to individual application components, whereas the screen 802 is used for defining bindings to columns of a table. The first binding shown in FIG. 8 is between a First Name table column 808 and a FirstName web services object attribute 810.

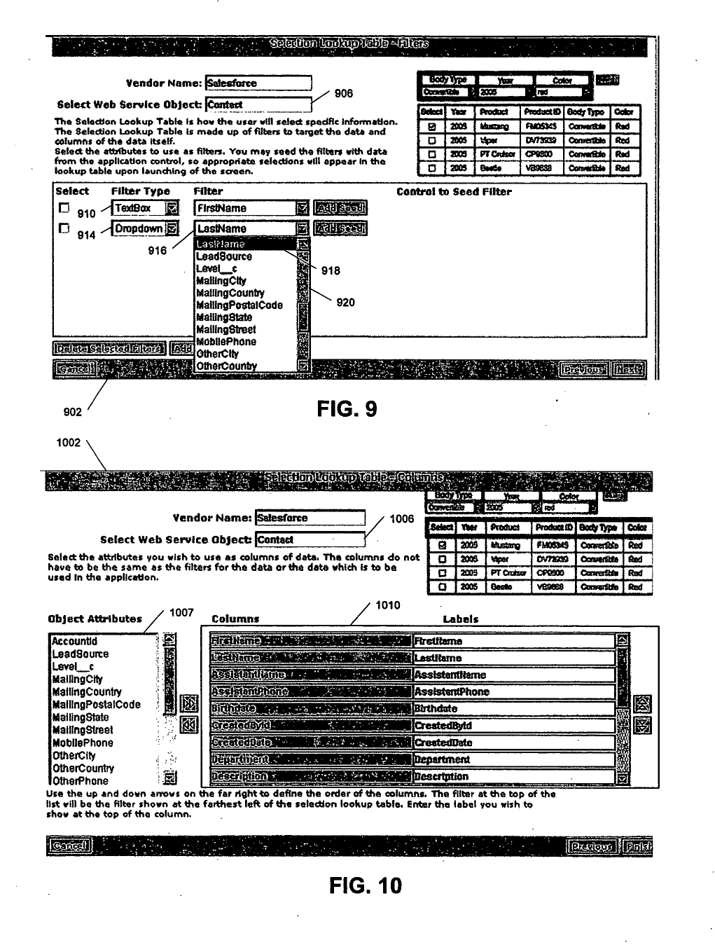

FIG. 9 is an illustrative drawing of adding filters for a table lookup in a web services Designer. The filter definition screen 902 of FIG. 9 is similar to the screen 502 of FIG. 5A and displays a list 920 of attributes that can be used to filter results.

FIG. 10 is an illustrative drawing of adding columns in a web services Designer. The column definition screen 1002 of FIG. 10 is similar to the screen of FIG. 6B and displays a list 1007 of object attributes that can be selected as the attributes that are to be retrieved from the web service when a lookup interaction is performed.

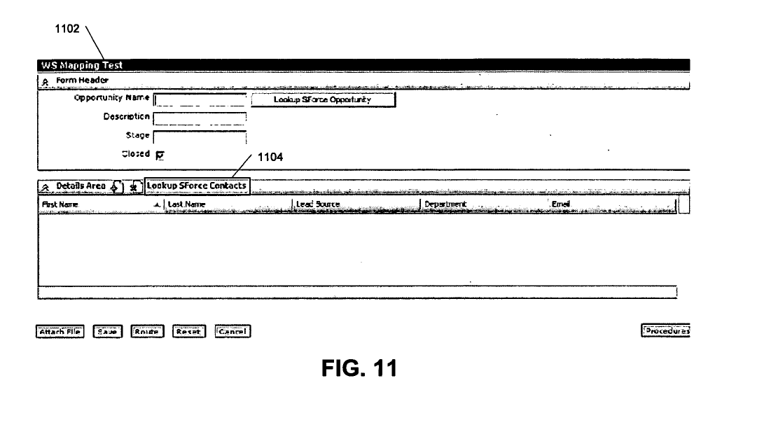

FIG. 11 is an illustrative drawing of an application in an Application Player. The application 1102 includes a Lookup SForce Contact button 1104, which was defined using the application Designer user interface shown in FIG. 2B. A user of the application 1102 can press the Lookup SForce Contact button 1104 to display a Selection Lookup Table for retrieving values for the application components, e.g., a Opportunity Name and a Description, from a web service according to the bindings.

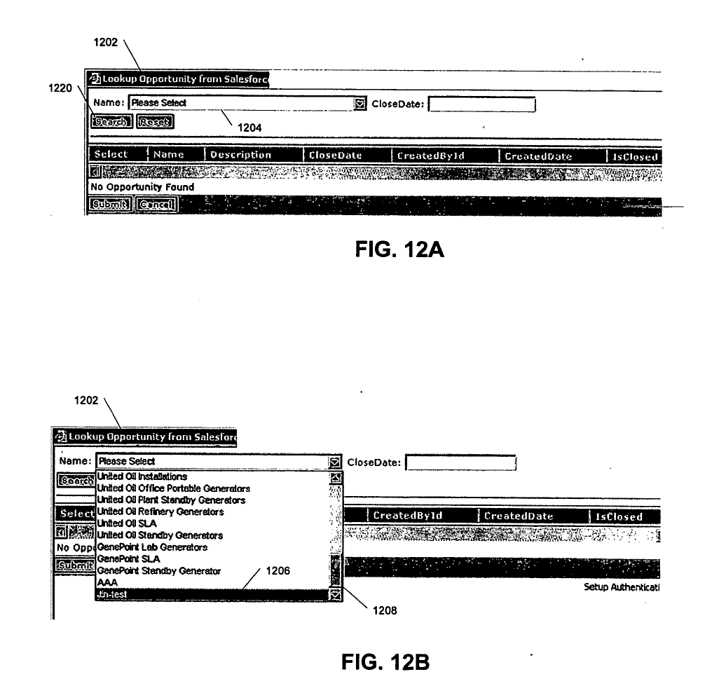

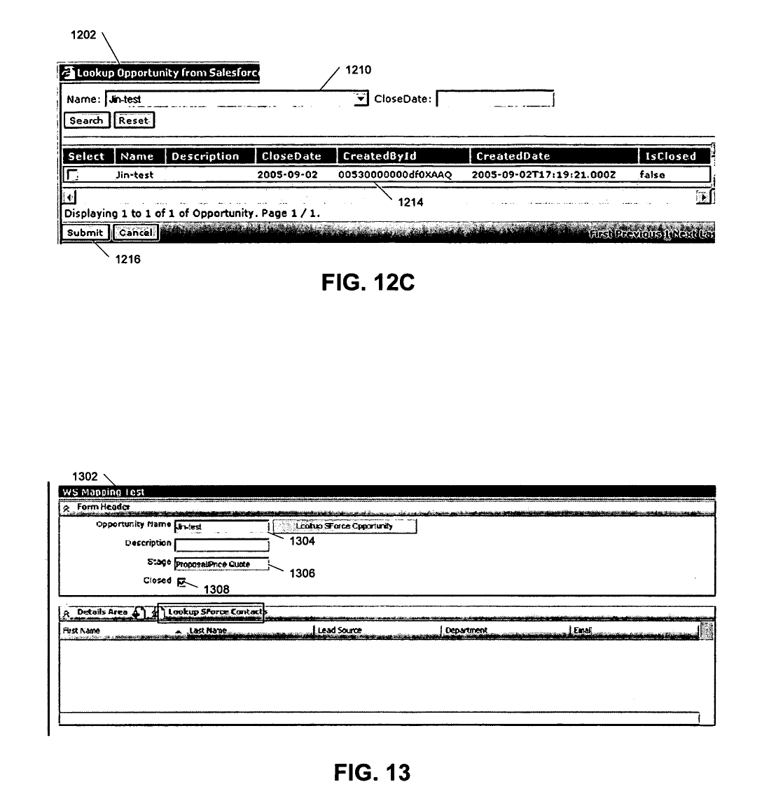

FIGS. 12A-12C are illustrative drawings of a Selection Lookup Table in a web services Player. FIG. 12A shows a Selection Lookup Table 1202 which includes an object name selector 1204 and a search button 1220. The object name selector 1204 can be used-to choose a particular web services object. FIG. 12B shows a list of web services objects, which is displayed as a menu 1208 when the object name selector 1204 is activated by a user, e.g., by clicking a mouse on the object name selector 1204. The menu 1208 includes a selected web services object 1208, which has been selected by a user. In FIG. 12C, a web services object 1210 has been selected, and the search button 1220 has been pressed. As a result of pressing the search button 1220, a list of web service object instances has been generated. The list includes a single instance 1214, which includes values for Name, ClassDate, CreatedById, CreatedDate, and IsClosed attributes. When a user clicks the submit button 1216, those values will be copied to a table in the web services Player 112 as specified by the bindings.

FIG. 13 is an illustrative drawing of an application in an Application Player with data retrieved from a web service. An Opportunity Name component 1304, a Stage component 1306, and a Closed component 1308 have received values from corresponding web service attributes according to the bindings.

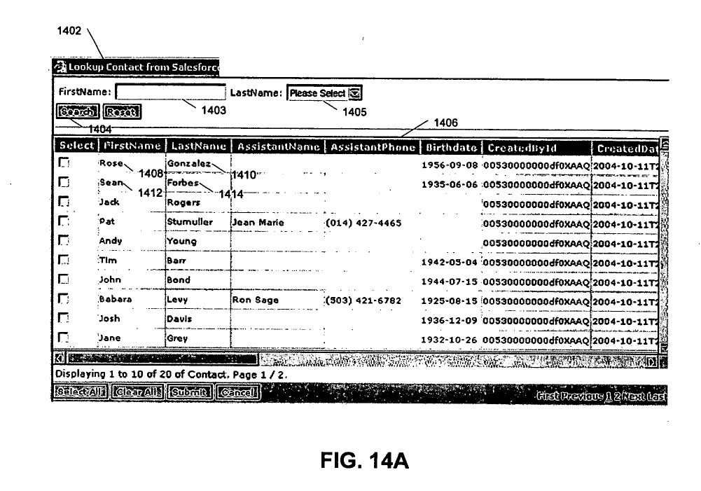

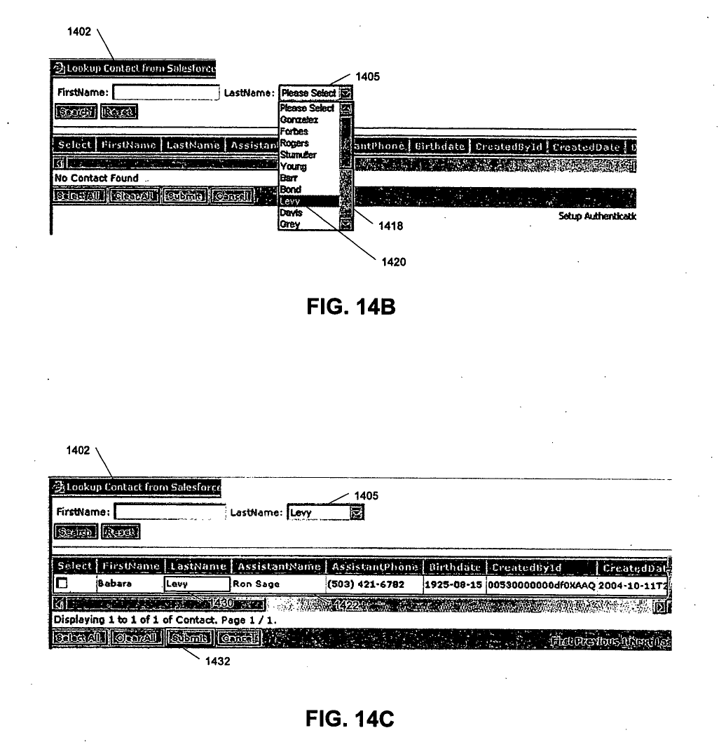

FIGS. 14A-14C are illustrative drawings of a selection lookup table in a web services Player. In FIG. 14A, a search button 1404 has been pressed, and as a result, multiple rows of data have been retrieved into a table 1406 from a web service according to the bindings. FIG. 14B shows filtering by an attribute (LastName) 1405 using a Dropdown list 1418. A user has selected a value 1420 (Levy) from the last name list. As a result, the table 1406 is restricted to displaying only the rows for which the LastName attribute is equal to Levy. In this example, there is only one such row 1422. Finally, in FIG. 14C, the user can click the submit button 1432 to transfer the values of all selected rows to the corresponding components of the application, according to the mappings.

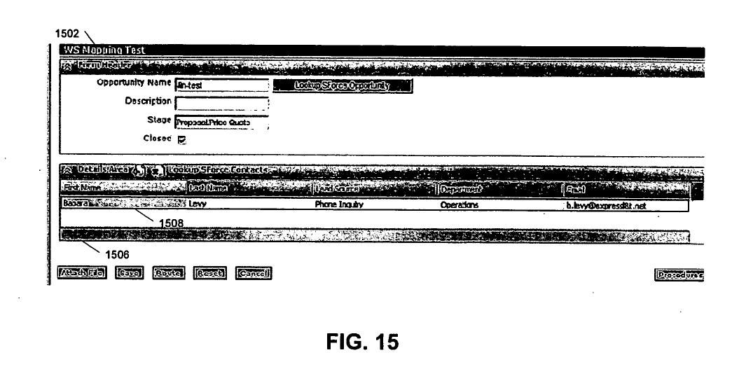

FIG. 15 is an illustrative drawing of an application in an Application Player with data retrieved from a web service. The application 1502 includes a table 1506, which has a single row of data 1508 transferred from the Selection Lookup Table 1402 of FIG. 14C. The row of data 1508 includes the LastName Levy 1430 and other values as shown in FIG. 14C.

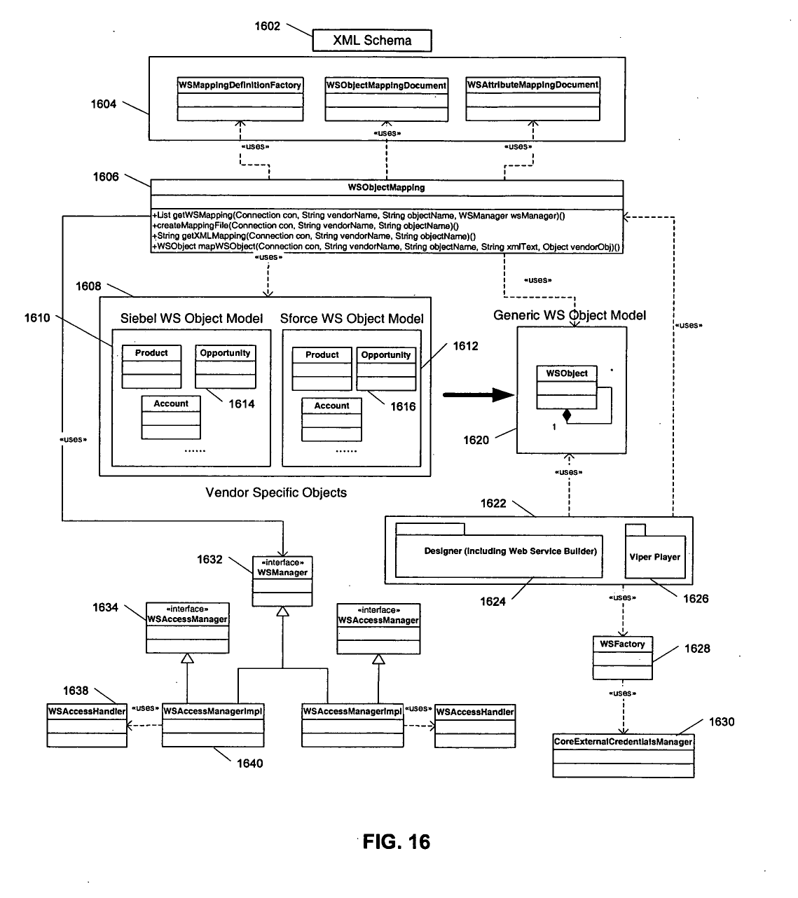

FIG. 16 is an illustrative drawing of implementation interfaces and objects. FIG. 16 shows a WSObjectMapping class 1606, which corresponds to the WSObjectMapping 123 of FIG. 1A. The WSObjectMapping class 1606 maps vendor specific objects 1608, including a Siebel Opportunity 1614 and a Salesforce Opportunity 1616, to a Generic-web services object model 1620, which is used by a Designer 1624 and a Player 1626. The WSObjectMapping class 1606 includes a getWSMapping method for retrieving existing mappings, a createMapping method for creating mappings, and a getXMLMapping method for getting an XML representation of the mappings.

Details of the implementation of the WS Player 112 will now be described with reference to the features shown in the preceding figures and the components shown in FIG. 1A. The WS Player 112 calls the WS Credential Manager 128 authenticate the user credentials. The WS Player 112 displays the Selection Lookup Table and the results list 1402 of FIG. 14A. The WS Player 112 uses a Pagination component (not shown) to display the page numbers and navigation links in the results list 1402. When the end of the current result set returned from the server 120 is reached, the Pagination component calls the WSLookupBean 125 to get the next result set. The WS Player 112 calls the WSLookupBean 125 whenever the user clicks the Selection Lookup Table Search button 1220 shown in FIG. 12A. The WS Player 112 passes the filter field values and lookup table columns to the WSLookupBean 125. The WSLookupBean 125 creates a query string based on the filter fields and lookup table columns and passes the query string to the WSFactory 132, which receives the query string and makes the underlying web service call to the web service, e.g., the Siebel web service 140, via the Siebel WS adapter 134. The WSFactory 132 then returns the result set of the web service call to the WSLookupBean 125. The WSLookupBean 125 calls the WSObjectMapping 123 with the result set to convert the vendor specific object into a generic WSObject 130. The WSObjectMapping 123 returns the WSObject 130 to the WSLookupBean 125, which returns the WSObject 130 to the WS Player 112, which displays the result set data in the Selection Lookup Table, e.g., as the result list 1402 of FIG. 14A. The user then selects the required rows and clicks a Submit button. Then the WS Player 112 populates the application components of the Player 106 according to the bindings 102.

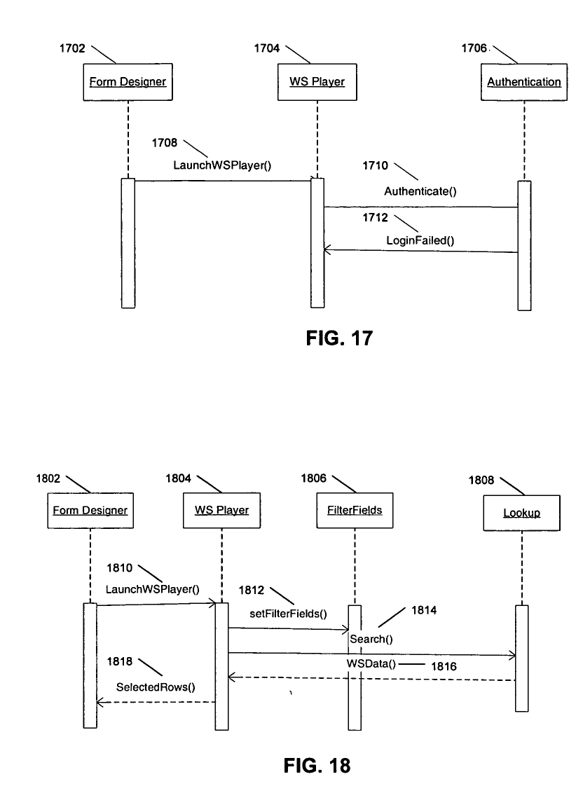

FIG. 17 is an illustrative drawing of a process for authenticating a user. The user must authenticate himself to the WS Vendor. If the authentication fails then the user will not be able to see the filter columns and the lookup table.

FIG. 18 is an illustrative drawing of a process for invoking a lookup. The WS Player 112 first be started~and p resented to a user. The user will then select the filter fields and click a submit button. The WS Player 112 will call the lookup component, which makes a web service call and displays web service data in the lookup table.

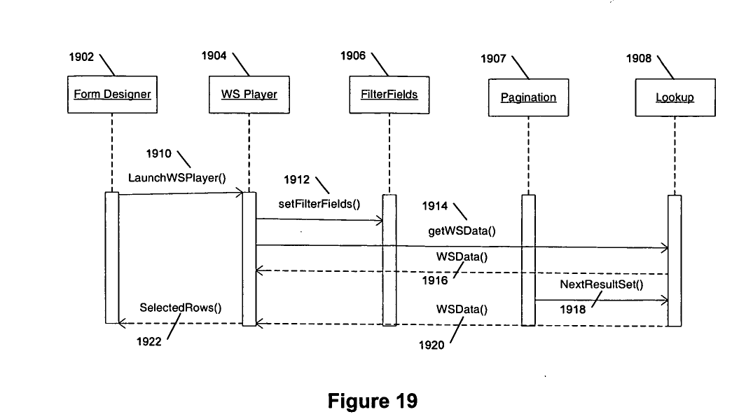

FIG. 19 is an illustrative drawing of a process for processing multiple pages of results. The WS Player 112 is first started and presented to a user. The user will then select the filter fields and then click submit. The WS Player 112 will then call the lookup component which makes a corresponding web service call and displays the web service data in the lookup table. When the end of the current result set is reached the pagination component will request the next result set from the Lookup component.

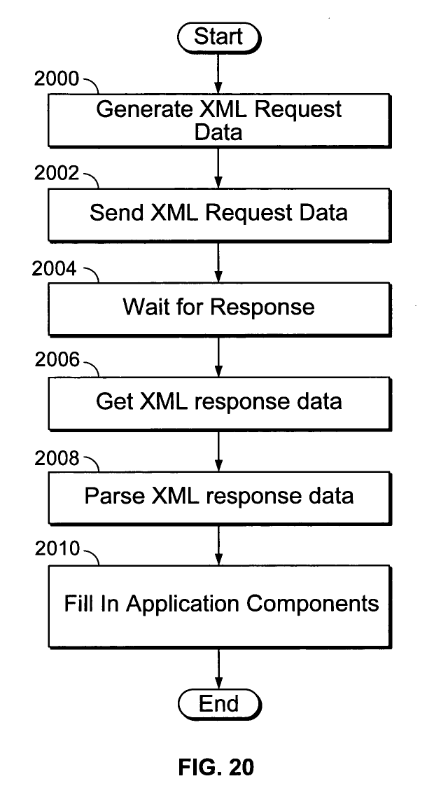

FIG. 20 is a flowchart of an exemplary portion of a method to be executed by a Designer or a Player for looking up web service objects. The method can be used to lookup web service objects via AJAX. The method begins at block 2000 by generating an XML representation of the request data, which corresponds to the invocation XML document 117 of FIG. 1A. The request data is sent to a server (e.g., an application server or web server) at block 2002, and the method waits for a response from the server at block 2004. After receiving a response, the method gets the XML data from the response at block 2006. The XML response data corresponds to the response XML document 119 of FIG. 1A. Next, the XML response data is parsed at block 2008 into a format suitable for processing in the programming language in use (e.g., JavaScript™). Finally, at block 2010, the response data is used to fill in the application components with values.

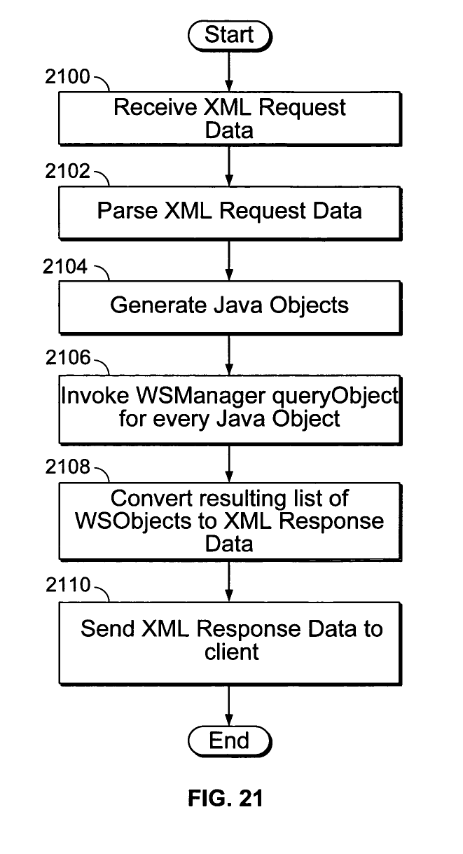

FIG. 21 is a flowchart of an exemplary portion of a method to be executed by a server for looking up web service objects. The method can be used by a server to process requests to lookup web service objects. The method begins at block 2100 by receiving a request, e.g., from an AJAX component of a browser. The request includes XML data in the format of the invocation XML document 117 of FIG. 1A (and Appendixes B and C). At block 2102, the method parses the data in the XML request to extract the input data for the lookup, e.g., a web service object name, filters, and columns. At block 2104, the method generates Java objects which represent the data in the XML request. At block 2106, the method invokes the WSManager's queryObject method for every Java object generated in block 2104 to retrieve objects from the web service. The queryObject method returns a list of WSObjects that represent the web service object instances retrieved from the web service by queryObject. At block 2108, the method converts the WSObjects to XML data in the format of the response XML document 119 of FIG. 1A (and Appendixes B and C). At block 2110, the method sends the XML data as a response, e.g., to a client such as the Internet Browser 101 of FIG. 1A, or to software running in the browser, such as the Designer 104 or the Player 106 of FIG. 1A, which delivers the data to the application.

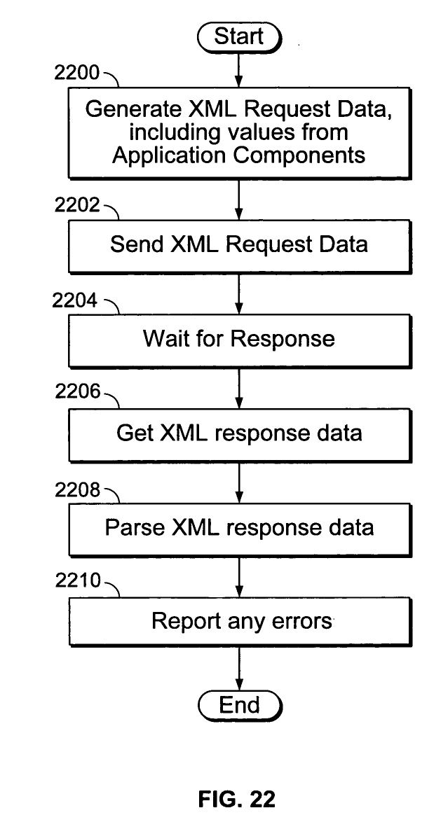

FIG. 22 is a flowchart of an exemplary portion of a method to be executed by a Designer or a Player for inserting, updating, or deleting web service objects. The method can be used to insert, update, or delete web service objects via AJAX. The method begins at block 2200 by generating an XML representation of the request data, which corresponds to the invocation XML document 117 of FIG. 1A. The request data is sent to a server at block 2202, and the method waits for a response from the server at block 2204. After receiving a response, the method gets the XML data from the response at block 2206. The XML response data corresponds to the response XML document 119 of FIG. 1A. Next, the XML response data is parsed at block 2208 to check for any errors that may have occurred on the server. The server sends error indications as part of the XML response data. Any errors that occur can then be reported to the user.

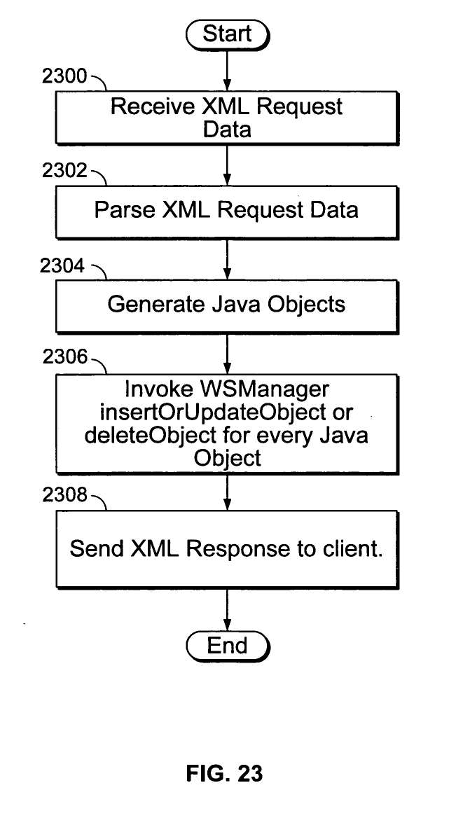

FIG. 23 is a flowchart of an exemplary portion of a method to be executed by a server for inserting, updating, or deleting web service objects. The method can be used by a server to process requests to insert, update, or delete web service objects. The method begins at block 2300 by receiving a request, e.g., from an AJAX component of a browser such as the Internet Browser 101 of FIG. 1A. The request includes XML data in the format of the invocation XML document 117 of FIG. 1A (and Appendixes B and C). At block 2302, the method parses the data in the XML request to extract an operation type (e.g., insert, update, or delete), a web service object name, and data that is to be inserted, updated, or deleted from the web service object. At block 2304, the method generates Java objects which represent the data in the XML request. At block 2306, the method invokes the WSManager's insertOrUpdateObject method if the operation to be performed is an insert or update, or the WSManager's deleteObject method if the operation is a delete. The WSManager method is invoked for every object specified in the XML request data. At block 2308, the method sends the XML data as a response, e.g., to the AJAX client, which delivers the data to the application.

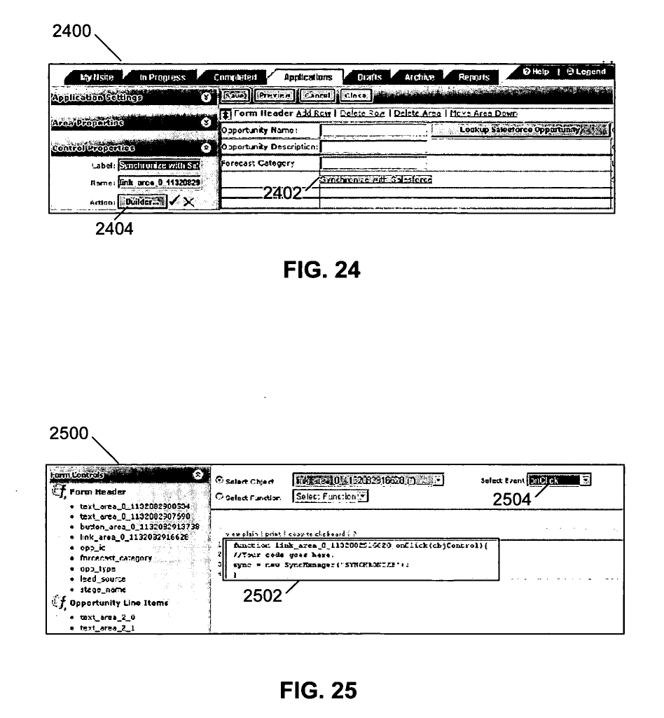

FIG. 24 is an illustrative drawing of a Designer user interface. The Designer interface 2400 is being used to design an application. The application includes a link 2402 named Synchronize with Salesforce. A user can create a script to be associated with the button 2402 by clicking an action builder button 2404.

FIG. 25 is an illustrative drawing of a user-defined script in an action builder. An action builder 2500 is a user interface component of the Application Designer 104. The action builder appears when a user clicks the action builder button 2404 for an application component such as the link 2402 of FIG. 24. The action builder 2500 allows a user to write a script 2502 associated with an event 2504. The action builder is described in more detail in commonly owned Patent Application entitled “Browser Based Designer and Player,” filed Sep. 30, 2005, inventors Pawan Nachnani et al., incorporated by reference above. The script 2502 includes a SyncManager SYNCHRONIZE call, which causes data values in application components (e.g., text fields and other components) to be stored in associated web service according to the bindings present in the application. The SYNCHRONIZE call also updates application components with values from the web service according to the bindings.

In addition to the SYNCHRONIZE call, the script can also call the SyncManager to insert, update, delete, or query objects in the web service according to the bindings, as shown in Table 7.

TABLE 7

| Script Call | Description |
|---|---|
| SyncManager(“INSERTUPDATE”) | Inserts new (or updates existing) |
| | values from the application into |
| | object(s) in the web service. |
| SyncManager(“DELETE”) | Deletes object(s) from the web |
| | service. |
| SyncManager(“QUERY”) | Looks up and retrieves objects |
| | from the web service. |
| SyncManager(“SYNCHRONIZE”) | Performs INSERTUPDATE |
| | followed by DELETE to |
| | delete web service objects that |
| | no longer exist in the |
| | application. |

The SyncManager calls automatically extract data from the application based on the bindings. The bindings can be either those created by a web services builder or bindings created programmatically in the script prior to calling the SyncManager.

This disclosure is illustrative and not limiting; further modifications will be apparent to those skilled in the art in light of this disclosure and are intended to fall within the scope of the appended claims.

APPENDIX A
<?xml version=“1.0” encoding=“UTF-8”?>
<xs:schema xmlns:xs=“http://www.w3.org/2001/XMLSchema”>

<xs:elementname=“WSObjectMapping”>

<xs:complexType>

<xs:sequence maxOccurs=“unbounded”>

<xs:element ref=“WSAttributeMapping”/>

</xs:sequence>
<xs:attribute name=“wsvendorname” type=“xs:string”
use=“required”/>
<xs:attribute name=“wsobjectname” type=“xs:string”
use=“required”/>

</xs : complexType>

</xs:element>
<!--Attribute has properties-->
<xs:elementname=“WSAttributeMapping”>

<xs:complexType>

<xs:attribute name=“wsattributename” type=“xs:string”
use=“required”/>
<xs:attribute name=“wsattributetype” type=“xs:string”
use=“required”/>
<xs:attribute name=“wsobjectattributename”
type=“xs:string”

use=“required”/>

</xs:complexType>

</xs:element>

</xs:schema>

APPENDIX B
<document pid=‘some_number’ ppid=‘some_number’>
<object name=‘some_object’ vendor=‘vendor_name’
action=‘INSERTUPDATE’>

<record>

<field name=‘attribute_name1’><![CDATA[some
text]]></field>
<field name=‘attribute_name2’><![CDATA[some
text]]></field>
<field name=‘attribute_name3’> <![CDATA[some
text]]></field>
<field name=‘attribute_name4’> <![CDATA[some
text]]> </field>

</record>

</object>
<object name=‘some_object’ vendor=‘vendor_name’
action=‘DELETE’>

<record>

<field name=‘wsAttributeID’><![CDATA[some
id value]]>
</field>
</field>

</record>
<record>

<field name=‘wsAttributeID’><![CDATA[some
id value]]>
</field>
</field>

</record>

</object>

</document>

APPENDIX C
<?xml version=‘1.0’ encoding=‘UTF-8’?>
<document pid=‘5124’ ppid=‘441’>
<object name=‘Account’ vendor=‘Salesforce’
action=‘INSERTUPDATE’>
<record>
<field name=‘Fax’>(212) 555-1212</field>
<field name=‘Name’>http://www.uos.com</field>
<field name=‘Website’>http://www.uos.com</field>
</record>
<record><field name=‘Fax’>+44 555 1234567</field>
<field name=‘Name’>http://www.uos.com</field>
<field name=‘Website’>http://www.uos.com</field>
</record>
<record>
<field name=‘Fax’>(555) 551-1234</field>
<field name=‘Name’>www.universityofarizona.com</field>
<field name=‘Website’>www.universityofarizona.com</field>
</record>
</object>
<object name=‘Account’ vendor=‘Salesforce’
action=‘INSERTUPDATE’>
</object>
</document>

APPENDIX D
<WebServiceBinding vendorname=“Salesforce”
objectname=“Opportunity”

username=“” wsurl=“https://www.salesforce.com/services/Soap/u/6.0 ”>

<WSAttributeBindingList>

<WSAttributeMapping formentity=“OppNameTextArea”

wsattribute=“OppName”/>

<WSAttributeMapping formentity=“DescriptionTextArea”

wsattribute=“Description”/>

<WSAttributeMapping formentity=“StageTexArea”

wsattribute=“StageName”/>

<WSAttributeMapping formentity=“ClosedCheckbox”

wsattribute=“IsClosed”/>

</WSAttributeBindingList>
<WSFilterBindingList>

<WSFilterField filterfieldwsattribute=“OppName”
formentity=“”

filterfieldtype=“Dropdown”/>

<WSFilterField filterfieldwsattribute=“CloseDate”
formentity=“”

filterfieldtype=“TextBox”/>

</WSFilterBindingList>
<WSTableBindingList>

<WSLookupTableColumn wsobjattribute=“OppName”

label=“Name” sortable=“false”/>

<WSLookupTableColumn wsobjattribute=“Description”

label=“Description” sortable=“false”/>

<WSLookupTableColumn wsobjattribute=“CloseDate”

label=“CloseDate” sortable=“false”/>

<WSLookupTableColumn wsobjattribute=“CreatedById”

label=“CreatedById” sortable=“false”/>

<WSLookupTableColumn wsobjattribute=“CreatedDate”

label=“CreatedDate” sortable=“false”/>

<WSLookupTableColumn wsobjattribute=“IsClosed”

label=“IsClosed” sortable=“false”/>

</WSTableBindingList>

</WebServiceBinding>

What is claimed as new and desired to be protected by Letters Patent of the United States is:

1. A computer enabled method for using a web service, comprising the acts of:
a first organization accessing a web services object of a second organization, wherein the accessing is via a web browser and over a computer network; and
binding at least a portion of the accessed web services object to a software object of the first organization, wherein the web services object is operable to interact with the software object.

2. The method of claim 1, wherein the software object is an application component, further comprising the acts of:
receiving a request for the accessed web services object, wherein the request is associated with the software object; and
executing the accessed web services object using a portion of the application component bound to the software object.

3. A computer enabled method for using a web service which supports a web services object, comprising the acts of:
identifying the web services object;
receiving a request for the web services object, wherein the request is associated with an application component; and
executing the web services object in response to the request.

4. The method of claim 1, wherein the accessed web services object has an associated description, and the act of accessing includes accessing the description.

5. The method of claim 4, wherein the description is in Web Services Description Language format.

6. The method of claim 1, further comprising the act of providing an adapter associated with the web services object.

7. The method of claim 1, wherein the act of binding binds a first software object to a second software object.

8. The method of claim 2, further comprising the act of providing a builder adapted to carry out the acts of accessing and binding thereby to enable the subsequent act of executing.

9. The method of claim 8, further comprising the act of providing a player adapted to carry out the act of executing.

10. The method of claim 8, wherein the builder is embodied in a web page executed on a web browser.

11. The method of claim 9, wherein the player is embodied in a web page executed on a web browser.

12. The method of claim 1, wherein the act of accessing includes making a web service call.

13. The method of claim 2, wherein the act of executing includes making a web service call.

14. The method of claim 1, further comprising the acts of:
accessing a software object of the first organization; and
combining the object of the first organization with the accessed web services object of the second organization.

15. The method of claim 14, wherein the software object of the first organization includes data.

16. The method of claim 1, wherein the web services object is accessible via an open protocol.

17. The method of claim 1, further comprising the act of binding at least a portion of the web services object to the software object of the first organization.

18. The method of claim 1, further comprising the act of enabling the method by a server of a third organization.

19. A computer enabled method for using a web service, comprising the acts of:
a second organization allowing a first organization access to a web services object of the second organization, wherein the accessing is via a web browser and over a computer network; and
binding at least a portion of the accessed web services object to a software object of the first organization, wherein the software object is operable to interact with the bound portion of the web services object.

20. The method of claim 19, wherein the accessed web services object has an associated description, and the act of accessing includes accessing the description.

21. The method of claim 20, wherein the description is in Web Services Description Language format.

22. The method of claim 19, further comprising the act of providing an adapter associated with the web services object.

23. The method of claim 19, wherein the act of binding binds a first software object to a second software object.

24. The method of claim 19, further comprising the act of providing a builder adapted to carry out the acts of accessing and binding.

25. The method of claim 19, further comprising the act of providing a player adapted to execute the web services object.

26. The method of claim 24, wherein the builder is embodied in a web page executed on a web browser.

27. The method of claim 25, wherein the player is embodied in a web page executed on a web browser.

28. The method of claim 19, wherein the act of accessing includes making a web service call.

29. The method of claim 19, wherein the software object is operable to interact with the bound portion of the web services object by making a web service call.

30. The method of claim 19, further comprising the acts of:
accessing the software object of the first organization; and
combining the software object of the first organization with the accessed web services object of the second organization.

31. The method of claim 30, wherein the software object includes data.

32. The method of claim 19, wherein the web services object is accessible via an open protocol.

33. The method of claim 19, further comprising the act of enabling the method by a server of a third organization.

34. A computer enabled apparatus for using a web service, comprising:
a factory module which creates instances of a web services object;
a credentials manager coupled to the factory module and which verifies a web services object accessed via a web browser and over a computer network;
a web services manager coupled to the factory module and which manages web service sessions;
an event manager which manages access to the accessed web services object; and
an adapter coupled to the web services manager and which maps the accessed web services object to the created instance of the web services object.

35. The apparatus of claim 34, wherein the factory module binds software objects in the accessed web services object to software objects in the created instance.

36. The apparatus of claim 34, further comprising a software application that accesses data using the web services object.

37. The apparatus of claim 34, further comprising an access handler coupled to the adapter.

38. The apparatus of claim 34, wherein the accessed application component has an associated description, and the accessing accesses the description.

39. The apparatus of claim 38, wherein the description is in Web Services Description Language format.

40. The apparatus of claim 34, wherein the accessing includes making a web service call.

41. The apparatus of claim 34, wherein the web services object is accessible via an open protocol.

42. A computer enabled method for generating a generic object which represents a web service, comprising the acts of:
identifying the generic object representing the web service, the web service having a plurality of attributes; and
creating a field in the generic object for each attribute of the web service, wherein the field has a name, a type, and a value based upon a corresponding attribute of the web service.

43. A computer enabled method for generating a description of a web service in XML format, comprising the acts of:
identifying a plurality of fields of the web service object; and
creating an XML element for each identified field of the web service object.

44. A computer enabled method for invoking a web service, comprising the acts of:
generating a request according to a predefined format;
sending the request to a web service by using AJAX;
waiting for a response from the web service;
receiving a response from the web service, wherein the response is in a predefined format; and
updating application components based on the response.

45. The method of claim 44, wherein the method is performed by a computer program code script executed by an application player in response to a user's selection of an application component associated with the script.

46. The method of claim 44, wherein the predefined format is XML.

47. A computer enabled method for invoking a web service, comprising the acts of:
receiving a request from a client , wherein the request includes request data in a predefined format;
generating objects based on the request data;
invoking a web service by using AJAX, wherein invoking is based on the objects;
converting at least one result of invoking the web service to at least one generic object;
converting the at least one generic object to response data in a predefined format; and
sending the response data to the client.

48. A method of designing an application program in a web browser, comprising the acts of:
executing a designer program on a web browser, wherein the designer program presents a user interface that includes a workspace upon which a user can place an interface component at a specified location,
the interface component associated with a component data value; and
associating the component with a computer program code script received from a user, wherein the computer program code script includes a web service call.

49. The method of claim 48, wherein the computer program code script is operable to set the value of another component based on a value received from a web service call.
